(19) United States
(12) Patent Application Publication
(10) Pub. No.: US 2025/0110343 A1
(43) Pub. Date: Apr. 3, 2025

(54) MULTI-COLOR SPACEPLATE

(71) Applicant: Cornell University, Ithaca, NY (US)

(72) Inventors: Francesco Monticone, Ithaca, NY (US); Masoud Pahlevaninezhad, Ithaca, NY (US)

(21) Appl. No.: 18/906,017

(22) Filed: Oct. 3, 2024

Related U.S. Application Data
(60) Provisional application No. 63/542,235, filed on Oct. 3, 2023.

(51) Int. Cl. G02B 27/09; G02B 27/42; G02F 1/29

(52) U.S. Cl. CPC G02B 27/0944; G02B 27/4294; G02F 1/292; G02F 2203/15

(57) ABSTRACT

A multi-color spaceplate includes a first component spaceplate and a second component spaceplate cascaded with the first component spaceplate. The first component spaceplate has an on-resonance compression ratio C₁₁ at a first resonance wavelength and, at a second resonance wavelength, an off-resonance compression ratio C₂₁, less than on-resonance compression ratio C₁₁. The second component spaceplate has an on-resonance compression ratio C₂₂ at the second resonance wavelength and, at the first resonance wavelength, an off-resonance compression ratio C₁₂ less than on-resonance compression ratio C₂₂. The multi-color spaceplate may include a third component spaceplate, cascaded with the first and second component spaceplates, and having: (i) an on-resonance compression ratio C₃₃ at a third resonance wavelength, (ii) at the first resonance wavelength, an off-resonance compression ratio C₁₃ that is less than on-resonance compression ratio C₃₃, and (iii) at the second resonance wavelength, an off-resonance compression ratio C₂₃ less than on-resonance compression ratio C₃₃.

### CROSS-REFERENCE TO RELATED APPLICATIONS

This application claims the benefit of U.S. Provisional Application No. 63/542,235, filed on Oct. 3, 2023, the disclosure of which is incorporated herein by reference in its entirety.

### STATEMENT REGARDING FEDERALLY SPONSORED RESEARCH

This invention was made with government support under Grant No. FA9550-22-1-0204 awarded by the Air Force Office of Scientific Research. The government has certain rights in the invention.

### BACKGROUND

A spaceplate is a photonic device that miniaturizes optical systems. Free-space between the components of an optical system takes by far the most volume of an optical system. A spaceplate has the same optical functionality as free-space over a distance d, e.g., as expressed by the transfer function of free space, while having a thickness less than distance d. A spaceplate may be placed anywhere in the optical path of an optical system to reduce the space between the components of the system.

To date, there is no spaceplate design to miniaturize optical devices in the visible region of the electromagnetic spectrum. Rather, existing spaceplate designs compress free-space within a limited bandwidth. Hence, these are effectively monochromatic spaceplates.

### SUMMARY OF THE EMBODIMENTS

The operating bandwidth of a spaceplate is constrained by strict physical bounds underlying generic space compression mechanisms. The fundamental trade-off between compression ratio and bandwidth, inherent in the optics of spaceplates, suggests that drastic space compression over the entire visible range is fundamentally challenging and far from feasible in practice, as it would require transparent materials with a large refractive index (e.g., a refractive index on the order of three to achieve a compression ratio of four). These physical bounds, however, only apply to spaceplates operating over continuous bandwidths, suggesting a possible strategy to bypass these issues.

Based on this insight, in this work we disclose “multi-color” spaceplates, embodiments of which operate at three distinct color channels over the visible spectrum to replace and compress free-space in color imaging systems. In embodiments, the space compression effect is based on the guided-mode resonances in dispersion-engineered coupled planar FP cavities made of amorphous TiO₂ and SiO₂ layers.

Embodiments of the disclosed multi-color spaceplates have high transmission efficiency and an achromatic response at three wavelengths with space compression ratios as high as ˜4.6, using dielectric materials with a refractive index less than ˜2.6.

Embodiments disclosed herein include a multi-wavelength spaceplate that achromatically compresses space for light propagation at three distinct color channels over the visible spectrum. The multi-wavelength spaceplate may include monochromatic (i.e., single-color) spaceplates. Analytic and simulation results confirm that a particular integration of monochromatic spaceplates forms a multi-wavelength spaceplate with an achromatic response at three wavelengths.

Compared to most previous designs of multilayer spaceplates, which were based on optimization methods, the disclosed spaceplates are designed through a rational approach rooted in the physics of wave propagation in FP cavities, which enables the design of scalable spaceplates with no limits on the number of layers. Conversely, design approaches based on standard brute-force optimization methods are not scalable in practice because the number of layers is significantly limited by trade-offs between the performance of the optimization algorithms and the number of degrees of freedom. More importantly, it is highly non-trivial to design a multi-color spaceplate with achromatic performance at three distinct colors.

Designing spaceplates with broadband or multi-band response has not been possible so far by relying on brute-force optimization. Simplifying the structural complexity required for high-performance space compression, making it amenable to rational design solutions, is in our opinion a significant strength of the disclosed approach.

In a first aspect, a multi-color spaceplate includes a first component spaceplate and a second component spaceplate cascaded with the first component spaceplate. The first component spaceplate has an on-resonance compression ratio C₁₁ at a first resonance wavelength and, at a second resonance wavelength, an off-resonance compression ratio C₂₁, that is less than the on-resonance compression ratio C₁₁. The second component spaceplate has an on-resonance compression ratio C₂₂ at the second resonance wavelength and, at the first resonance wavelength, an off-resonance compression ratio C₁₂ that is less than the on-resonance compression ratio C₂₂. The multi-color spaceplate may also include a third component spaceplate cascaded with the first component spaceplate and the second component spaceplate. The third component spaceplate has (i) an on-resonance compression ratio C₃₃ at a third resonance wavelength, (ii) at the first resonance wavelength, an off-resonance compression ratio C₁₃ that is less than the on-resonance compression ratio C₃₃, and (iii) at the second resonance wavelength, an off-resonance compression ratio C₂₃ that is less than the on-resonance compression ratio C₃₃.

### BRIEF DESCRIPTION OF THE FIGURES

FIG. 1 is a schematic of a multi-color spaceplate and converging optical beams incident thereon, in embodiments.

FIG. 2 is a schematic of a multi-color spaceplate that includes two cascaded component spaceplates and is an example of the multi-color spaceplate of FIG. 1.

FIG. 3 is a schematic of an optical cavity, which in an optical cavity of embodiments of the spaceplate of FIG. 2.

FIG. 4 is a schematic of a multi-color spaceplate, which is an example of the multi-color spaceplate of FIG. 2.

FIG. 5 is a schematic of an optical cavity, which is an example of the optical cavity of FIG. 3.

FIG. 6 is a schematic of a monochromatic spaceplate that includes multiple optical cavities of FIG. 5.

FIGS. 7-9 are plots of transmitted amplitude of embodiments of the monochromatic spaceplate of FIG. 6.

FIG. 10 shows plots of FDTD simulations of monochromatic space compression at visible wavelengths for embodiments of the spaceplates of FIG. 2.

FIG. 11 shows normalized intensity profiles across focal planes of the plots of FIG. 10.

FIG. 12 is a schematic of a multi-color spaceplate, which is an example of the multi-color spaceplate of FIG. 2.

FIGS. 13, 14, and 15 show the wavelength- and angle-dependent transmission plots of monochromatic spaceplates of the multi-color spaceplate of FIG. 12.

FIG. 16 includes plots showing the performance of the multi-color spaceplate of FIG. 12.

FIGS. 17 and 18 further illustrate the achromatic performance of the multi-color spaceplate of FIG. 12.

FIG. 19 is a schematic of a multi-color spaceplate, which is an example of the multi-color spaceplate of FIG. 2.

FIG. 20 shows transmission plots of monochromatic spaceplates of the multi-color spaceplate of FIG. 19.

FIG. 21 shows a transmission response of the multi-color spaceplate of FIG. 19.

FIG. 22 demonstrates the achromatic performance of the multi-color spaceplate of FIG. 19 across three color channels.

FIG. 23 shows transmission plots of monochromatic spaceplates of FIG. 6 for transverse-electric (TM) polarized light.

FIG. 24 includes plots showing transmitted amplitude and phase of a nine DBR-layer embodiment of the monochromatic spaceplate of FIG. 6.

FIG. 25 shows a transmission response of a spaceplate that includes five optical cavities each having fifteen layer pairs.

FIG. 26 is a schematic of a monochromatic spaceplate, which is an example of the monochromatic spaceplate of FIG. 6.

FIG. 27 illustrates a transmission response of the spaceplate of FIG. 26.

FIG. 28 shows the intensity profile of a TE polarized Gaussian beam propagating in vacuum and the beam propagation through the spaceplate of FIG. 26.

FIG. 29 compares a transmission profile of two monochromatic spaceplates, which are examples of the monochromatic spaceplate of FIG. 6.

FIG. 30 shows a transmission response of a multi-color spaceplate, which is an example of the multi-color spaceplate of FIG. 12.

FIG. 31 is a schematic of a transfer-matrix method used to analyze the transmission and reflection response of multilayer structures.

FIG. 32 shows a transmission amplitude and phase shift of an embodiment of the spaceplate of FIG. 6 after introducing random fabrication errors in layer thicknesses.

FIG. 33 illustrates an example method for fabricating the multi-color spaceplate of FIG. 2.

### DETAILED DESCRIPTION OF THE EMBODIMENTS

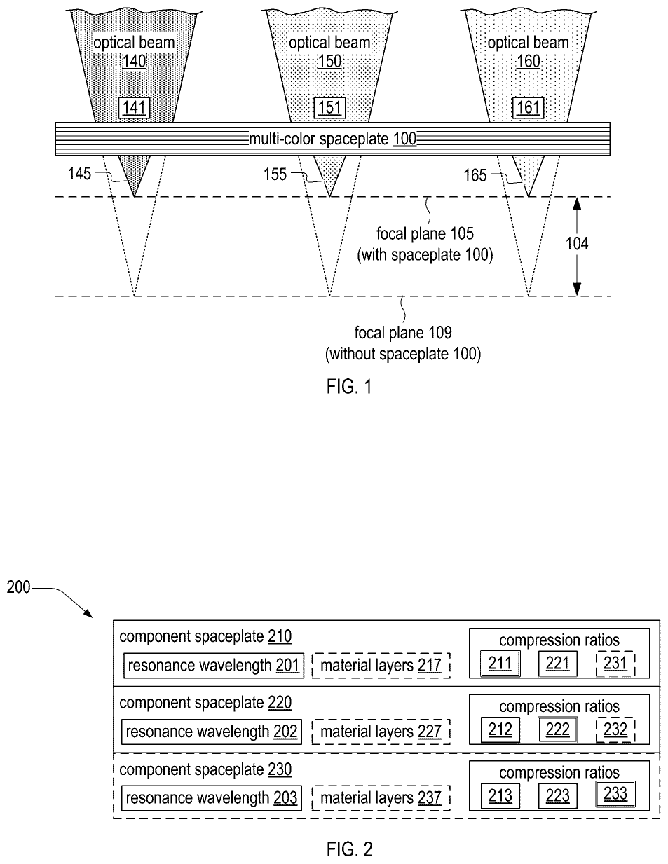

FIG. 1 is a schematic of a multi-color spaceplate 100 and converging optical beams 140, 150, and 160 incident thereon. Converging optical beams 140, 150, and 160 have respective center wavelengths 141, 151, and 161. Without multi-color spaceplate 100, each of converging optical beams 140, 150, and 160 would have a beam waist at a focal plane 109. Multi-color spaceplate 100 transmits converging optical beams 140, 150, and 160 as transmitted converging beams 145, 155, and 165, which have a beam waist at a focal plane 105, which is between focal plane 109 and multi-color spaceplate 100. Focal planes 109 and 105 are separated by a distance 104, herein also referred to as a space compression 104. In the example of multi-color spaceplate 100, distance 104 qualifies as an achromatic space compression.

Embodiments of multi-color spaceplate 100 may be integrated into, and decrease the size of, imaging systems such as cameras, AR/VR headsets, night-vision goggles, telescopes, and microscopes. Realizing space compression in the visible spectrum may lead to a new generation of ultra-thin optical systems, making the use of complex optical systems even more widespread in our daily lives. Even an embodiment of multi-color spaceplate 100 that has a compression ratio as low as two (twofold size reduction) for multiple color channels over the visible spectrum would still make a significant impact toward the miniaturization of many optical devices. AR/VR headsets, night-vision goggles, telescopes, microscopes, and cameras are among the many optical devices that may be made thinner and lighter in weight through the use of multi-color spaceplate 100.

FIG. 2 is a schematic of a multi-color spaceplate 200, which includes a component spaceplate 210 and a component spaceplate 220 that is cascaded with component spaceplate 210. Multi-color spaceplate 200 is an example of multi-color spaceplate 100. Component spaceplate 210 has an on-resonance compression ratio 211 (C₁₁) at a resonance wavelength 201 and, at a resonance wavelength 202, an off-resonance compression ratio 221 (C₂₁), that is less than on-resonance compression ratio 211. Component spaceplate 220 has an on-resonance compression ratio 222 (C₂₂), at resonance wavelength 202 and, at resonance wavelength 201, an off-resonance compression ratio 212 (C₁₂) that is less than on-resonance compression ratio 222. Resonance wavelengths 201, 202, and 203 are examples of center wavelengths 141, 151, and 161 introduced in FIG. 1.

Multi-color spaceplate 200 may be configured to be substantially transparent in at least two of a first spectral range that includes resonance wavelength 201, a second spectral range that includes resonance wavelength 202, and a third spectral range that includes resonance wavelength 203. The bandwidth of each of the first, second, and third spectral ranges may be at least ten nanometers or at least twenty nanometers. Herein, examples of “substantially transparent” include transmittance values of at least 75%. For example, the transmittance may be at least 80%, 85%, or 90%, between 75% and 100%, or within any subrange therein.

In embodiments, multi-color spaceplate 200 also includes a component spaceplate 230 that is cascaded with component spaceplate 210 and component spaceplate 220. Component spaceplate 230 has (i) an on-resonance compression ratio 233 (C₃₃) at a resonance wavelength 203, (ii) at resonance wavelength 201, an off-resonance compression ratio 213 (C₁₃) that is less than on-resonance compression ratio 233, and (iii) at resonance wavelength 202, an off-resonance compression ratio 223 (C₂₃) that is less than on-resonance compression ratio 233. In such embodiments, (i) component spaceplate 210 has an off-resonance compression ratio 231 (C₃₁), that is less than on-resonance compression ratio 211, and (ii) component spaceplate 220 has an off-resonance compression ratio 232 (C₃₂), that is less than on-resonance compression ratio 222.

Equation (1) defines s compression tensor C characterizing multi-color spaceplate 200. Compression tensor C includes the aforementioned compression ratios Cᵢⱼ, where the first index i denotes the wavelength of incident light and the second index j denotes the resonance wavelength of component spaceplate 210 (j=1), 220 (j=2), or 230

$$C = [ \begin{matrix}{C}_{11} & {C}_{21} & {C}_{31} \\ {C}_{12} & {C}_{22} & {C}_{32} \\ {C}_{13} & {C}_{23} & {C}_{33}\end{matrix} ] \qquad ( 1 )$$

Resonance wavelength 201 may be less than resonance wavelength 202, which may be less than resonance wavelength 203. Each of resonance wavelengths 201-203 may be in the range of 450 nm and 800 nm, or any subrange within this range. In embodiments, resonance wavelength 201 is between 380 nm and 490 nm, resonance wavelength 202 is between 490 nm and 560 nm, and resonance wavelength 203 is between 570 nm and 750 nm. Herein, resonance wavelengths 201, 202, and 203 are also denoted by λ₁, λ₂, and λ₃, respectively. Similarly, subscript k equals one of integers 1, 2, or 3, such that λₖ is one of resonance wavelengths 201-203.

One or more of on-resonance compression ratios 211, 222, and 233 may be greater than two, such that each component spaceplate of multi-color spaceplate 200 functions as a space plate at on-resonance wavelengths. One or more of off-resonance compression ratios 221, 231, 212, 232, 213, and 223 may be less or equal to one such that each component spaceplate of multi-color spaceplate 200 does not compress incident light incident having off-resonance wavelengths. For example, each of the off-resonance compression ratios may be less than or equal to 0.7.

In embodiments, component spaceplates 210, 220, and 230 include material layers 217, material layers 227, and material layers 237, respectively. Herein, where nₘₐₓ₁, nₘₐₓ₂, and nₘₐₓ₃ denote the maximum refractive index of the material layers 217, 227, and 237, respectively. In embodiments, we have found that these maximum refractive indices impose a lower limit on the values of off-resonance compression ratios. Hence, in embodiments, at least one of (i) off-resonance compression ratio C₂₁ exceeds 1/nₘₐₓ₁ and (ii) off-resonance compression ratio C₁₂ exceeds 1/nₘₐₓ₂. When multi-color spaceplate 200 includes component spaceplate 230, at least one (i) off-resonance compression ratio C₁₃ exceeds 1/nₘₐₓ₃, (iii) off-resonance compression ratio C₂₃ exceeds 1/nₘₐₓ₃.

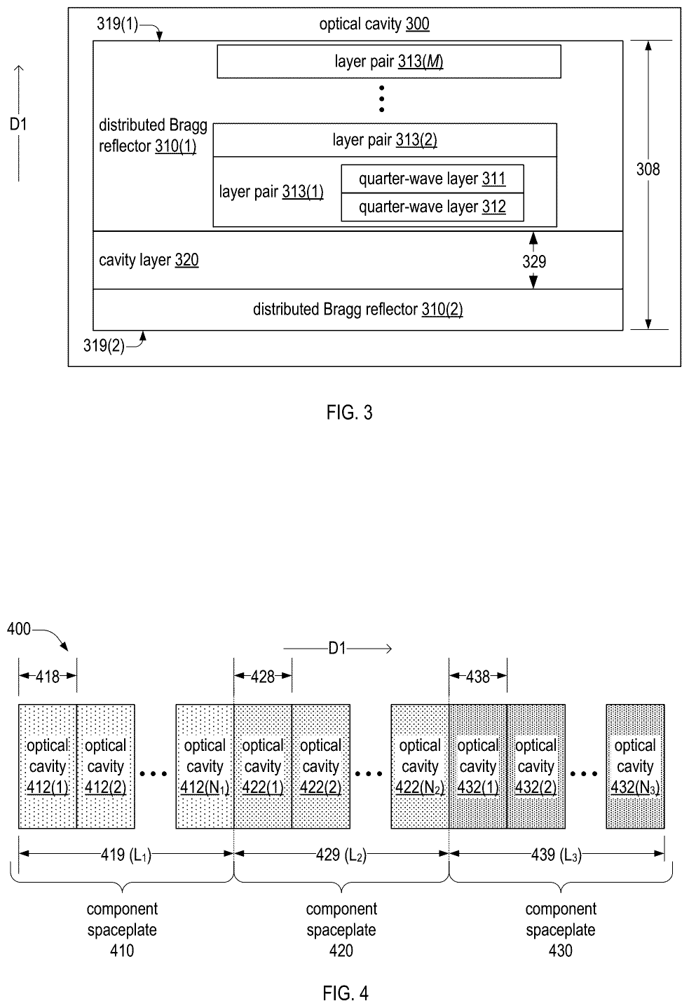

FIG. 3 is a schematic of an optical cavity 300, which may be a Fabry-Pérot cavity. Each component spaceplate 210, 220, and 230 may include at least one optical cavity 300. Optical cavity 300 includes a distributed Bragg reflector (DBR) 310(1), a DBR 310(2), and a cavity layer 320 between DBRs 310(1) and 310(2). Each DBR 310 includes a stack of M layer pairs 313 arrayed along a direction D1, where M is a positive integer. Each layer pair includes a quarter-wave layer 311 and a quarter-wave layer 312. Quarter-wave layer 311 has a geometric thickness equal to λₖ/4n₃₁₁(λₖ), n₃₁₁(λₖ) is the refractive index of quarter-wave layer 311 at wavelength λₖ. Quarter-wave layer 312 has a geometric thickness equal to λₖ/4n₃₁₂(λₖ), where n₃₁₂ (λₖ) is the refractive index of quarter-wave layer 312 at wavelength λₖ.

Candidate materials for quarter-wave layers 311 and 312 include silicon dioxide and titanium dioxide. In embodiments, one of quarter-wave layers 311 and 312 may be a silicon dioxide layer while the other of quarter-wave layers 311 and 312 is a titanium dioxide layer.

Along direction D1, cavity layer 320 has a thickness 329 that defines a distance between DBRs 310(1) and 310(2). Thickness 329 is a geometric thickness. Thickness 329 equal to mₖλₖ/2n₃₂₀(λₖ), where n₃₂₀(λₖ) is the refractive index of cavity layer 320 at wavelength λₖ, and mₖ is a positive integer. Optical cavity 300 has a length 308, which may be a distance between an exterior-facing surface 319(1) of DBR 310(1) and an exterior-facing surface 319(2) of DBR 310(2).

FIG. 4 is a schematic of a multi-color spaceplate 400, which is an example of multi-color spaceplate 200, FIG. 2. Multi-color spaceplate 400 includes a component spaceplate 410, a component spaceplate 420, and may also include a component spaceplate 430, which are respective examples of component spaceplates 210, 220, and 230, FIG. 2. Material layers 217, 227, and 237 may include cavity layer 320 and quarter-wave layers 311 and 312 of optical cavity 300, for example, when component spaceplates 210, 220, and 230 are component spaceplates 410, 420, and 430, respectively.

Component spaceplate 410 includes N₁ cascaded optical cavities 412 each having a resonance at resonance wavelength 201. Component spaceplate 420 includes N₂ cascaded optical cavities 422 each having a resonance at resonance wavelength 202. Component spaceplate 430 includes N₃ cascaded optical cavities 432 each having a resonance at resonance wavelength 203. Each of optical cavities 412, 422, and 432 is an example of optical cavity 300. Each of N₁, N₂, and N₃ is a positive integer.

Each optical cavity 412, 422, and 432 is an example of optical cavity 300, and hence has a cavity layer 320 having thickness 329. For cavities 412, 422, and 432, thickness 329 equals m₁λ₁/2n₃₂₀(λ₁), m₂Δ₂/2n₃₂₀(λ₂), and m₃λ₃/2n₃₂₀(λ₃), respectively.

Embodiments of multi-color spaceplate 400 with specific values of m₁, m₂, and m₃, and/or relationships among these quantities, have distinctively superior performance. Each of m₁, m₂, and m₃ is a design parameter used in designing multi-color spaceplates. These parameters may be selected in a way that monochromatic spaceplate components perform space compression near one specified wavelength and function as a high-transmission filter at other wavelengths.

In a first embodiment, one of m₁, m₂, and m₃ equals one, and the remaining two of m₁, m₂, and m₃ equaling two. In a second embodiment, m₁ equals one and resonance wavelength 201 is less than each of resonance wavelength 202 and resonance wavelength 203. In the second embodiment, m₂ and m₃ may equal two as in the first embodiment. In a third embodiments, each of m₁, m₂, and m₃ equals one.

Embodiments of multi-color spaceplate 400 with specific values of N₁, N₂, and N₃, and/or relationships among these quantities, have distinctively superior performance In a fourth embodiment, N₂ equals 5N₁/6 and N₃ equals N₂. In a fifth embodiment, N₁ equals thirty, N₂ equals thirteen, and N₃ equals five. Embodiments of multi-color spaceplate 400 may qualify as more than one of the above-mentioned first through fifth embodiments.

Along direction D1, optical cavities 412, 422, and 432 have respective lengths 418, 428, and 438, each of which is an example of length 308 of optical cavity 300. Also along direction D1, component spaceplate 410, component spaceplate 420, and component spaceplate 430 have respective lengths 419, 429, and 439, herein also denoted as L₁, L₂, and L₃. Lengths 419, 429, and 439 are equal to, respectively: N₁ times length 418, N₂ times length 428, and N₃ times length 438.

As respective examples of component spaceplates 210, 220, and 230, component spaceplates 410, 420, and 430 have are characterized by compression ratios Cᵢⱼ or compression tensor C, equation (1). Component spaceplates 410, 420, and 430 have respective focal-point shifts F₁, F₂, and F₃ defined by equations (2.1), (2.2), and (2.3).

$${F}_{1} = {L}_{1} ( {C}_{11} + {C}_{12} + {C}_{13} ) \qquad ( 2.1 )$$

$${F}_{2} = {L}_{2} ( {C}_{21} + {C}_{22} + {C}_{23} ) \qquad ( 2.2 )$$

$${F}_{3} = {L}_{3} ( {C}_{31} + {C}_{32} + {C}_{33} ) \qquad ( 2.3 )$$

In embodiments, integers N₁ and N₂ minimize a differences between focal-point shifts F₁ and F₂. When multi-color spaceplate 400 includes component spaceplate 430, integers N₁, N₂, and N₃ may minimize differences between focal-point shifts F₁, F₂, and F₃.

### Specific Spaceplate Embodiments

In the following sections, we first present a strategy to design monochromatic spaceplates with high transmission amplitudes and high compression factors at any visible wavelength. These monochromatic spaceplates are the building blocks of the disclosed multi-color spaceplates. Next, we demonstrate that such monochromatic spaceplates with tailored transmission responses may be coupled in a dispersion-engineered manner to create multi-color spaceplates that achromatically compress free-space at three visible wavelengths while maintaining high performance. Trivial combinations/cascades of monochromatic spaceplates would instead lead to drastic aberrations. The presented theoretical and computational results confirm the high performance of the disclosed spaceplates over the visible spectrum, in terms of transmission efficiency, usable angular range, and compression ratio. These findings may lead to the experimental demonstration of strong space-compression effects for visible light, a goal that has so far remained elusive.

### Monochromatic Spaceplates in at Visible Wavelengths

A nonlocal structure can perform space compression by implementing an angle-dependent transmission phase that matches the phase shift acquired by light propagating in free-space over a distance that exceeds the spaceplate's physical thickness. Existing spaceplate designs in the literature have been mainly based on photonic crystal slabs or multilayered thin films made of transparent materials with relatively high refractive indices, such as Si, which are common for infrared operation, but become highly lossy and dispersive in the visible range. Among the dielectric materials with a transparency window in the visible spectrum, amorphous TiO₂ (refractive-index n_{TiO}_{₂}≈2.3-2.6) and SiO₂ (refractive-index n_{SiO}_{₂}≈1.46-1.48) exhibit one of the highest refractive-index contrasts available. However, simply replacing Si with TiO₂ in existing spaceplate designs results in negligible or no space compression. To understand how to achieve good space-compression performance with lower refractive indices, we should first consider how space-compression effects are actually obtained. The most utilized physical mechanism for space compression is the angle-dependent phase and time delay provided by guided-mode resonances or FP-like resonances in planar structures. In particular, an FP cavity is arguably the simplest planar structure transmitting light at selected wavelengths with a strong angle-dependent phase shift. The compression ratio (C) of an FP cavity made of two semi-transparent mirrors with the same reflectance (R), separated by a medium with a refractive index n_{c}, is as follows:

$$C = \frac{1}{{n}_{c}} \frac{1 + R}{1 - R} \qquad ( 3 )$$

As indicated by Eq. (3), the space compression effect of an FP structure is mainly determined by the reflectance of mirrors, with a higher reflectance offering a higher space compression ratio. We also note that the angular range and bandwidth over which this structure actually works as a spaceplate, approximating the response of free-space, inversely scale with the compression ratio and may be very narrow for a single resonator¹⁸. Such fundamental tradeoff may be relaxed by increasing the number of resonances. Based on these ideas, realizing a spaceplate in the visible spectrum requires the use of high-reflectance mirrors made of relatively low-index materials, with virtually zero loss, and the suitable combination and coupling of multiple resonances.

Here, we propose a design where the reflective mirrors of a planar FP cavity are implemented as dielectric distributed Bragg reflectors (DBRs) composed of TiO₂ and SiO₂ layers. The constructive interference of reflected light from multiple layers of a DBR creates high overall reflectance within a wavelength range known as stop band. For normal incidence of light at a wavelength λ, the highest reflectance occurs when each layer of the DBR is a quarter-wavelength thick, λ/4n, where n is to the refractive index of the layer. The number of layers in the DBR determines its reflectance and, consequently, the compression ratio of the FP cavity. Increasing the number of layers results in higher compression ratios, but reduces the usable bandwidth and angular range.

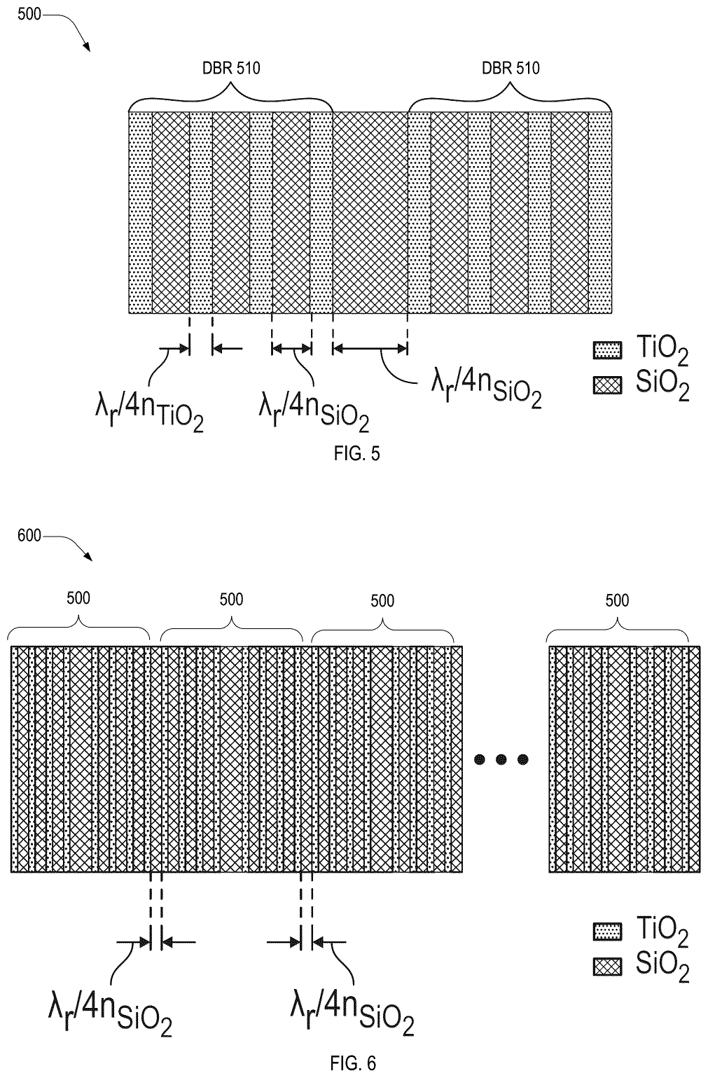

FIG. 5 is a schematic of an optical cavity 500 that includes two identical DBRs 510 separated by a layer with half-wavelength thickness, λᵣ/2n_{SiO}_{₂}, where λᵣ is the resonance wavelength. Each DBR includes seven alternating layers of TiO₂ and SiO₂, each with a quarter-wavelength thickness. FIG. 6 is a schematic of a monochromatic spaceplate 600 that includes multiple optical cavities 500 coupled through quarter-wavelength spacers. Monochromatic spaceplate 600 in an example of each component spaceplates 210, 220, and 230.

To demonstrate the performance of the disclosed structure for monochromatic space compression over the visible spectrum, we designed three spaceplates operating near the FP-like resonances at wavelengths: λᵣ=405 nm (violet), 535 nm (green), and 700 nm (red). The DBRs implemented in each FP cavity are composed of seven alternating layers of quarter-wavelength thick TiO₂ and SiO₂, and ten FP cavities are coupled to form a spaceplate at each wavelength.

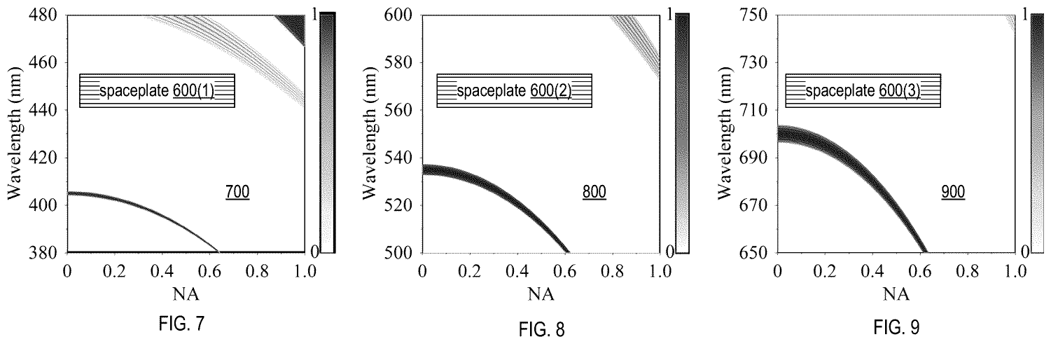

FIGS. 7-9 show the analytical results for the transfer functions of three spaceplates, using a standard transfer-matrix method. For clarity, these spaceplates are denoted as spaceplates 600(1), 600(2), and 600(3), each of which are examples of monochromatic spaceplate 600. Spaceplates 600(1-3) have the following respective resonance wavelengths: λᵣ=405 nm, λᵣ=535 nm, and λᵣ=700 nm. Each of FIGS. 7-9 includes three plots. The left plot, center plot, and right plot correspond to spaceplates 600(1-3) respectively.

To achieve space compression over the widest possible angular range, the operating wavelength (λ₀) of spaceplates 600(1-3) is chosen to be slightly off-resonance at normal incidence (at the edge of the bright line), where transmission amplitude is still high and the phase shift has an approximately quadratic response vs. incident angle, matching that of free-space.

FIGS. 7, 8, and 9 shows transmission plots 700, 800, and 900 of monochromatic spaceplates 600(1-3), respectively, with respect to wavelength and numerical aperture of a transverse-electric (TE) polarized optical beam in free-space. The dark lines correspond to the dispersion curves of the modes supported by the structure. The width of these dark lines may be increased with the number of coupled resonances, enabling operation over wider angular and wavelength ranges. For the spaceplates 600(1-3) operating at respectively wavelengths λ₀=404.4, 533.6, and 697.6 nm, a space compression factor of 9.5, 5.6, and 4.8 is achieved over numerical apertures (NAs) of 0.16, 0.2, and 0.22, respectively.

Spaceplate 600(1), when operating at λ₀=404.4 nm, replaces a free-space length of ˜88.97 μm with a thickness of ˜9.32 μm, corresponding to a compression ratio of 9.5 over NA=0.16. Spaceplate 600(2), when operating at λ₀=533.6 nm, replaces a free-space length of ˜72.04 μm with a thickness of ˜12.73 μm, corresponding to a compression ratio of 5.6 over NA=0.20. Spaceplate 600(3), when operating at λ₀=697.6 nm, replaces a free-space length of ˜80.22 μm with a thickness of ˜16.87 μm, corresponding to a compression ratio of 4.8 over NA=0.22.

FIGS. 1-7 demonstrate the high performance of the designed spaceplates, made of transparent dielectric materials, for visible wavelengths. Within the angular window of space compression, the transmission phase accurately matches the free-space propagation phase while maintaining a high transmission amplitude. Furthermore, the transverse-invariant structure of the spaceplates leads to space compression that is virtually polarization-insensitive (the transverse wave impedances for TE and TM incident waves are similar for relatively small angles, leading to similar reflection/transmission at planar boundaries). In embodiments of spaceplates disclosed herein, spaceplates with shorter operating wavelengths yield higher space compression ratios for the same number of layers. The compression ratio of the spaceplate designed to operate near λᵣ=405 nm is almost twice as high as the one near λᵣ=700 nm. This is mainly due to frequency dispersion and the resulting higher refractive index contrast of the TiO₂ and SiO₂ layers at shorter wavelengths in the visible spectrum, which enhances the reflectivity of DBRs. As shown in FIG. 24, by increasing the number of layers in the DBRs to nine layers, a compression ratio of 9.8 is attainable also near λᵣ=700 nm. As the compression ratio increases, the operating NA and bandwidth of the spaceplate decrease, as seen in FIG. 7. These considerations are important for the design of multi-wavelength spaceplates with achromatic response in the next section.

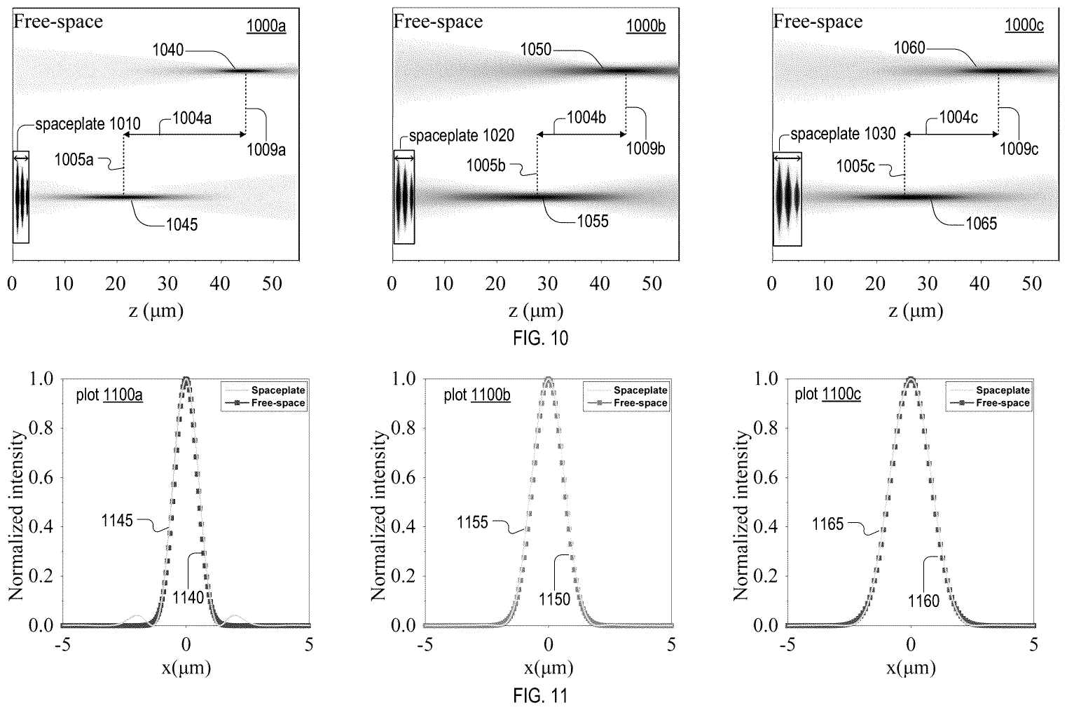

FIG. 10 shows plots 1000a, 1000b, and 1000c of FDTD simulations of monochromatic space compression at visible wavelengths for spaceplates 1010, 1020, and 1030, which are respective examples of component spaceplates 210, 220, and 230. Plots 1000a-1000c depict converging optical beams 1040, 1050, and 1060 propagating through respective spaceplates 1010, 1020, and 1030, which transmit the optical beams as optical beams 1045, 1055, and 1065. Optical beams 1045, 1055, and 1065 are examples of transmitted converging beams 145, 155, and 165, respectively.

Each of optical beams 1040, 1050, and 1060 is a TE polarized Gaussian beam (NA=0.14) propagating in vacuum and has respective free-space wavelengths λ₀=404.4 nm, λ₀=533.6 nm, and λ₀=697.6 nm. Each of spaceplates 1010, 1020, and 1030 includes three coupled FP cavities with seven TiO₂/SiO₂ layer pairs in their DBRs and have respective thicknesses of approximately 2.79 μm, 3.81 μm, and 5.05 μm.

Plots 1000a-1000c denotes a free-space focal planes 1009a-1000c and 1005a-1005c, which are separated by respective space compressions 1004a-1004c, each of which are examples of space compression 104 introduced in FIG. 1. Respective values of space compressions 1004a, 1004b, and 1004c are 22.9 μm, 16.7 μm, and 17.6 μm, which correspond to respective space compression ratios of 9.2, 5.4, and 4.5.

FIG. 11 shows plots 1100a, 1100b, and 1100c, which include normalized intensity profiles across focal planes 1004a, 1004b, 1004c, 1009a, 1009b, and 1009c of plots 1000a, 1000b, and 1000c of FIG. 10, respectively. Plot 1100a includes normalized intensity profile 1145 of optical beam 1045 and normalized intensity profile 1140 of optical beam 1040. Plot 1100b includes normalized intensity profile 1155 of optical beam 1055 and normalized intensity profile 1150 of optical beam 1050. Plot 1100c includes normalized intensity profile 1165 of optical beam 1065 and normalized intensity profile 1160 of optical beam 1060.

As shown in FIGS. 10 and 11, spaceplates 1010, 1020, and 1030 realize space compression by shifting the focal point of the beam in vacuum toward the spaceplate. Consistent with our analytical results, FDTD simulations prove that monochromatic spaceplates designed at λᵣ=405, 535, and 700 nm provide a strong space compression ratios. Notably, the intensity profile at the focal plane of the beam propagating through the spaceplate is almost identical to the corresponding profile for propagation in free-space (FIG. 11). Hence, the nonlocal angle-dependent response of the disclosed spaceplates effectively reduces the focal distance of the beam without changing its properties. In other words, the entire field distribution is shifted toward the spaceplate with minimal distortion, which implies that such spaceplates may be used to reduce the length of a monochromatic imaging system without any change in its focusing and magnification power.

### Multi-Color Spaceplates in at Visible Wavelengths

The fractional bandwidth of spaceplates 600, 1010, 1010, 1020, and 1030 is on the order of 1%. Such a limited bandwidth would be a major barrier to the miniaturization of many optical devices in the visible wavelength range, such as color imaging systems. While strong compression of free-space over the full visible spectrum appears to be fundamentally difficult as discussed above, a multi-color spaceplate operating at three (or more) distinct color channels over the visible spectrum, and not over a continuous bandwidth, is a promising alternative solution to miniaturize color imaging systems without incurring in the fundamental bandwidth tradeoffs. However, as further discussed in the following, it is highly non-trivial to design a single spaceplate with achromatic performance, in terms of transmission efficiency, compression ratio, and angular range, at different wavelengths.

Embodiments of multi-color spaceplates disclosed here are based on a combination of monochromatic spaceplates, where each monochromatic element is designed to perform space compression near one specified wavelength and function as a high-transmission filter at other wavelengths. Based on this concept, we developed a multi-color spaceplate operating near λᵣ=405, 535, and 700 nm.

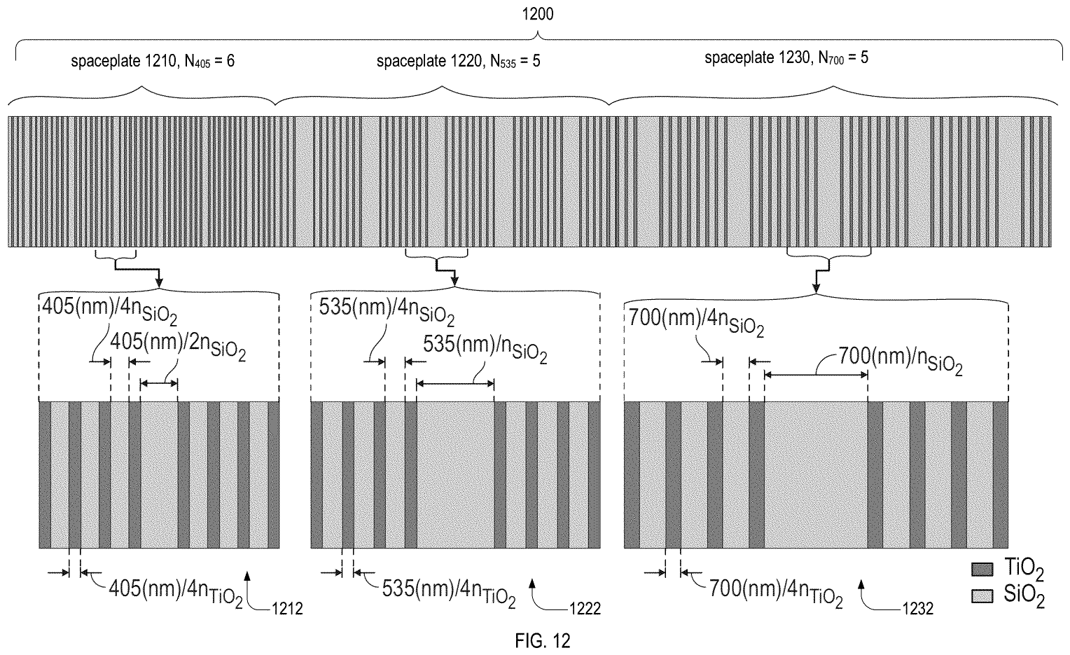

FIG. 12 is a schematic of a multi-color spaceplate 1200, which includes monochromatic spaceplates 1210, 1220, and 1230. Spaceplate 1200 is an example of multi-color spaceplate 200. Spaceplates 1210, 1220, and 1230 are examples of component spaceplate 210, 220, and 230, respectively. Monochromatic spaceplate 1210 includes six FP cavities 1212 each having seven TiO₂/SiO₂ layer pairs in its DBRs, designed at a resonance wavelength λᵣ=405 nm. Monochromatic spaceplate 1220 includes six FP cavities 1222 each having seven TiO₂/SiO₂ layer pairs in its DBRs, designed at a resonance wavelength λᵣ=535 nm. Monochromatic spaceplate 1220 includes five FP cavities 1232 each having seven TiO₂/SiO₂ layer pairs in its DBRs, designed at a resonance wavelength λᵣ=700 nm. FP cavities 1212, 1222, 1232 are respective examples of optical cavities 412, 422, and 432.

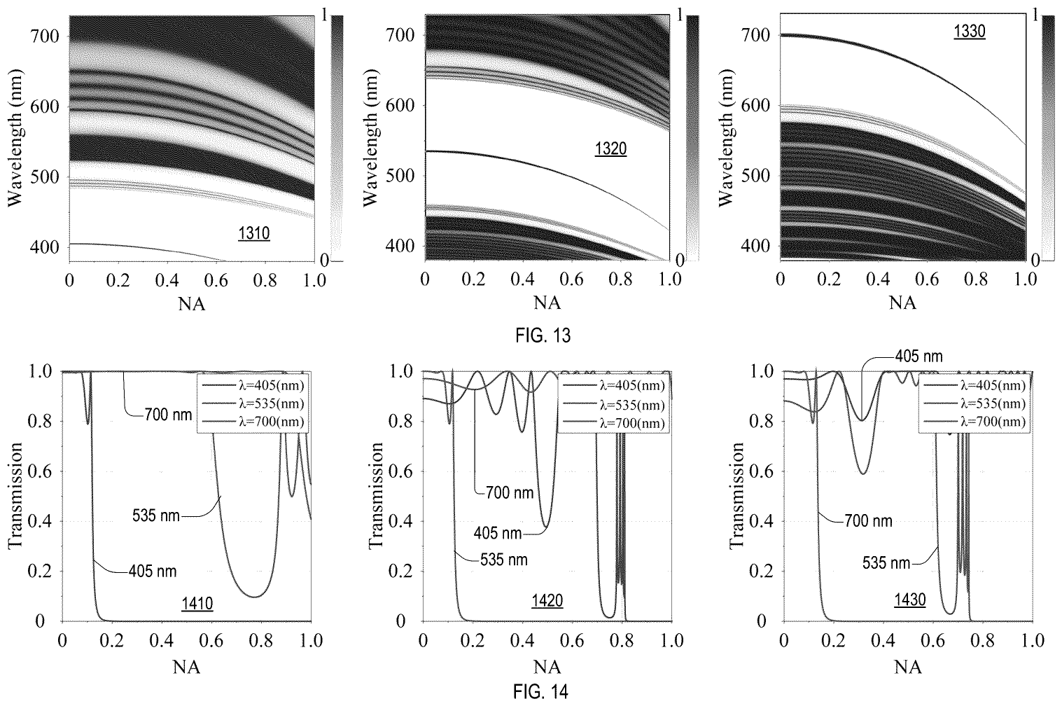

FIG. 13 shows the wavelength- and angle-dependent transmission plots 1310, 1320, and 1330 of monochromatic spaceplates 1210, 1220, and 1230, respectively.

FIG. 14 includes plots 1410, 1420, and 1430, which show angle-dependent transmission amplitude of spaceplates 1210, 1220, and 1230 respectively at the three resonance wavelengths. Each spaceplate performs space compression at one wavelength and transmits the incident light at the two other wavelengths with high efficiency.

Crucial for the performance of a multi-color spaceplate, monochromatic spaceplate 1210 transmits light with high efficiencies at the two other wavelengths, λ=535 and 700 nm (FIG. 14). To achieve similar high-transmission performance for monochromatic spaceplates 1220 and 1230, the FP cavities implemented in these spaceplates compress free-space using the second-order resonance, such that the other two wavelengths fall within transparency windows (more generally, the order of the resonance may be used as an additional degree of freedom to design multi-wavelength spaceplates). In this configuration, DBRs in FP cavities are separated by a one-wavelength layer (instead of half-wavelength) at resonance.

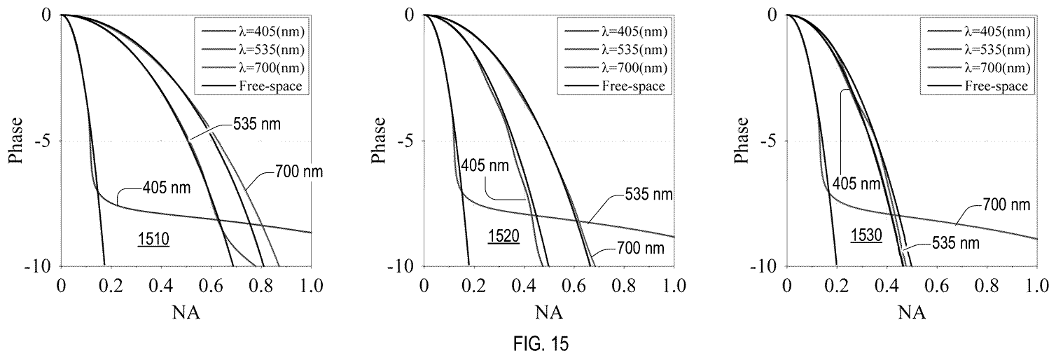

FIG. 15 includes plots 1510, 1520, and 1530, which show angle-dependent transmission phase of spaceplates 1210, 1220, and 1230 respectively. The plotted phase is for TE polarized light incident on the monochromatic spaceplates compared to the phase shift acquired through free-space propagation. Monochromatic spaceplate 1210 has thickness of ˜4.65 μm and replaces a free-space length of ˜42.52 μm at λ=405 nm, ˜3.1 μm at λ=535 nm, and ˜2.7 μm at λ=700 nm, corresponding to compression ratios of C_{405,405}=9.13, C_{535,405}=0.67, and C_{700,405}=0.58. Monochromatic spaceplate 1220 has a thickness of ˜7.26 μm and replaces a free-space length of ˜4.86 μm at λ=405 nm, 52.43 μm at λ=535 nm, and ˜4.41 μm at λ=700 nm, corresponding to compression ratios of C_{405,535}=0.67, C_{535,535}=7.22, and C_{700,535}=0.61. Monochromatic spaceplate 1230 has thickness of ˜9.62 μm and replaces a free-space length of ˜5.67 μm at λ=405 nm, ˜6.42 μm at λ=535 nm, and ˜56 μm at λ=700 nm, corresponding to compression ratios of C_{405,700}=0.59, C_{535,700}=0.67, and C_{700,700}=5.8.

FIG. 15 shows the angle-dependent transmission phase of monochromatic spaceplates 1210-1230 and how they match the free-space phase shift at the three selected wavelengths over a certain angular range (note that the angle-dependent free-space propagation phase changes at different wavelengths). To combine monochromatic spaceplates 1210-1230 to create multi-color spaceplate 1200 with an achromatic response, one should also account for how the presence of additional structure affects the compression ratio at each wavelength.

To do that, we define a compression tensor C, whose elements C_{i,j} correspond to the compression ratios of the monochromatic spaceplate resonating at λᵣ=j nm when light with λ=i nm wavelength passes through it. For the monochromatic spaceplates described above, the compression tensor is:

$$C = [ \begin{matrix}{C}_{405 , 405} = 9.13 & {C}_{535 , 405} = 0.67 & {C}_{700 , 405} = 0.58 \\ {C}_{405 , 535} = 0.67 & {C}_{535 , 535} = 7.22 & {C}_{700 , 535} = 0.61 \\ {C}_{405 , 700} = 0.59 & {C}_{535 , 700} = 0.67 & {C}_{700 , 700} = 5.8\end{matrix} ]$$

While each monochromatic spaceplate 1210-1230 performs space compression near its resonance wavelength (C_{i,j}>1, for i=J), refraction of light in a high-transmission filter introduces a counter space-compression effect (C_{i,j}<1, for i≠j). This is attributed to the refractive indices of the layers being higher than the refractive index of free-space, n_{Tio}_{₂} & n_{SiO}_{₂}>1. (Indeed, one can easily see that propagation through a non-resonant dielectric slab in free-space leads to less-than-unity compression ratio due to refraction).

Embodiments of multi-color spaceplate 200, such as multi-color spaceplate 1200, achromatically compresses free-space at three wavelengths. For example, multi-color spaceplate 200 may be designed using a dispersion-engineered composition of monochromatic spaceplates that achieve the same compression factor at each wavelength, taking into account the “space expansion” effect of the other cascaded spaceplates:

$${\sum }_{j = 405 , 535 , 700} {L}_{j} {C}_{405 , j} = {\sum }_{j = 405 , 535 , 700} {L}_{j} {C}_{535 , j} = {\sum }_{j = 405 , 535 , 700} {L}_{j} {C}_{700 , j} \qquad ( 4 )$$

In Eq. (4), Lⱼ is the thickness of the monochromatic spaceplate resonating at λᵣ=j nm. The overall achromatic compression ratio of the multi-color spaceplate is then simply given by any of the sums in Eq. (4) divided by the total length. The achromatic condition specified by Eq. (4) may be met by adjusting the Lⱼ factors through the number of FP cavities (Nⱼ) implemented in each monochromatic spaceplate. For the case considered here, we found that the combination of N₄₀₅=6, N₅₃₅=5, N₇₀₀=5 elements nearly satisfies the condition for multi-color spaceplate 1200 to have an achromatic response at the selected wavelengths.

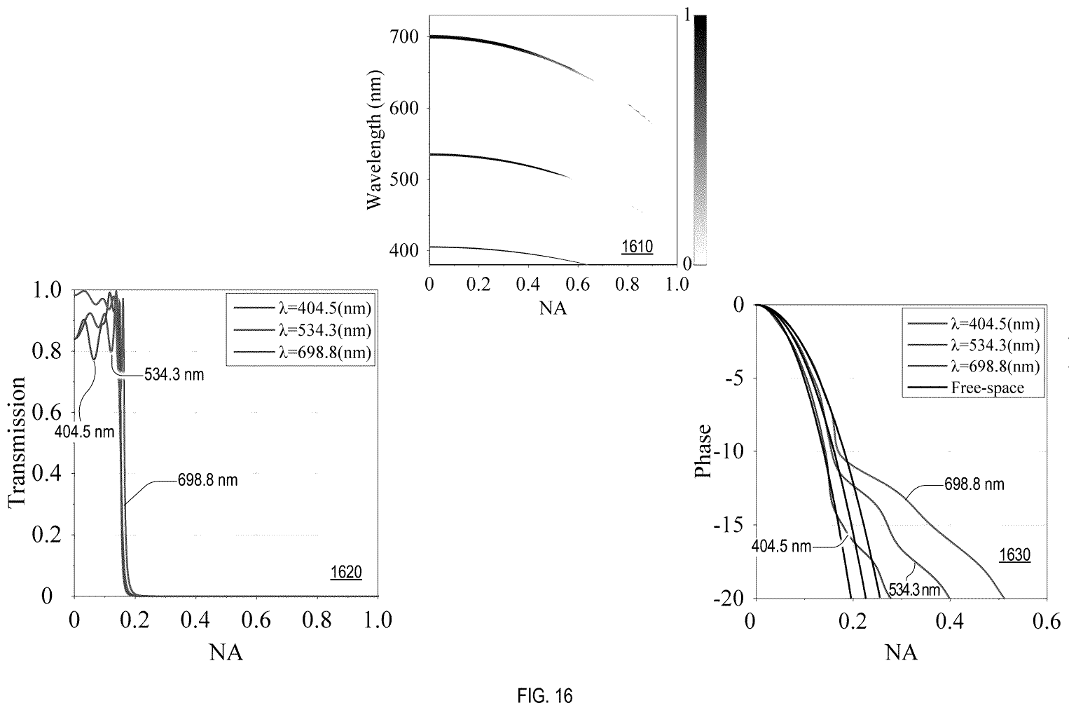

The layout of multi-color spaceplate 1200 is schematically illustrated in FIG. 12. FIG. 16 includes plots 1610, 1620, and 1630 showing the performance of multi-color spaceplate 1200. Plot 1610 shows the wavelength- and angle-dependent transmission profile of spaceplate 1200 across the visible spectrum. Consistent with the transmission response of the constituent monochromatic spaceplates (FIGS. 13-15.), three high-transparency bands emerge near the wavelengths at which the multi-color spaceplate is designed to perform space compression. Plots 1620 and 1630 show the transmission amplitude and phase with respect to the angle of incidence at the three operating wavelengths of λ₀=404.5, 534.3, and 698.8 nm. The high transmission amplitude and the excellent match between the transmission phase of the spaceplate and of free-space at the three selected wavelengths clearly demonstrate its achromatic response, achieving a compression ratio of ˜3 over NA ˜0.15 (FIG. 16), close to the numerical aperture of modern smartphones (NA ˜0.26).

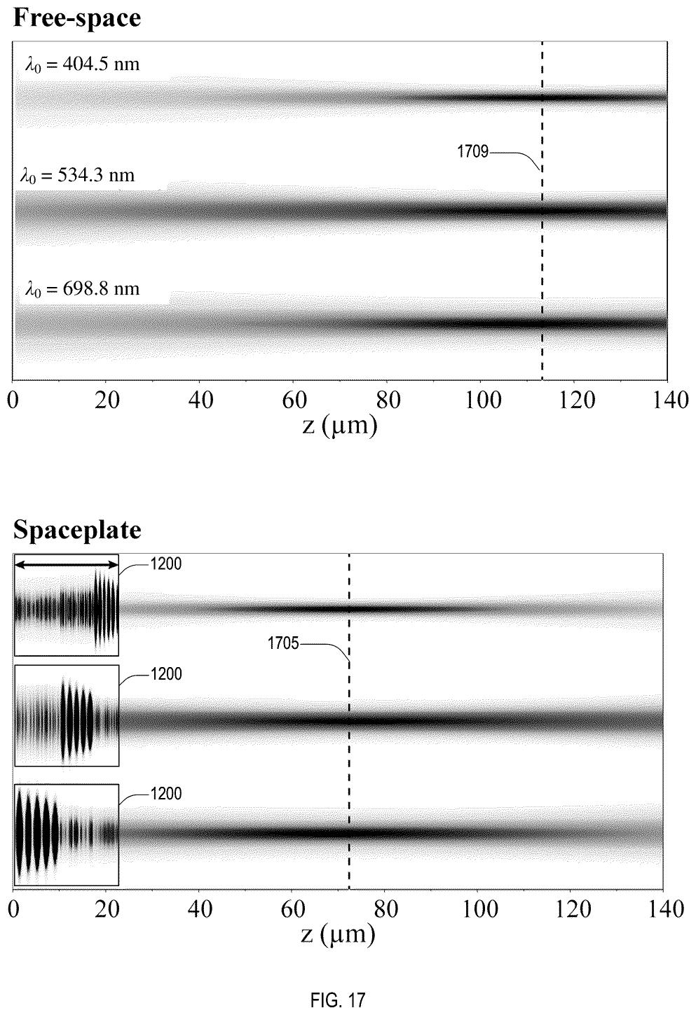

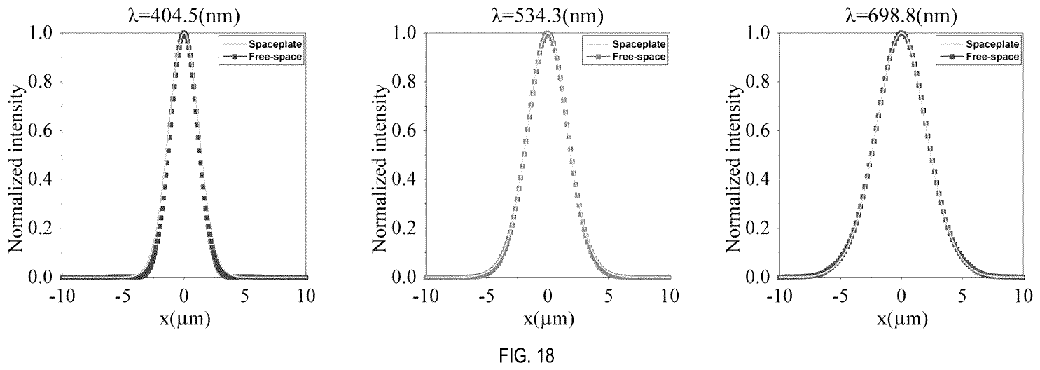

FIG. 17 further illustrates the achromatic performance of multi-color spaceplate 1200 through FDTD simulations. Comparing the propagation of a Gaussian beam in free-space and in the presence of multi-color spaceplate 1200 at three wavelengths, the achromatic response of the designed multi-color spaceplate is evident. The focal point of the beam shifts nearly identically across the three color channels. As shown in FIG. 17, at each wavelength, the resonance of coupled FP cavities within the corresponding monochromatic spaceplate element determines a transverse shift of the beam (see the tapered shape of the enhanced fields in different sections of the spaceplate at different wavelengths) that results in the desired space-compression effect. FIG. 18 shows that the intensity profile at the focal plane of the beam propagating through the spaceplate is almost identical to the corresponding profile for propagation in free-space.

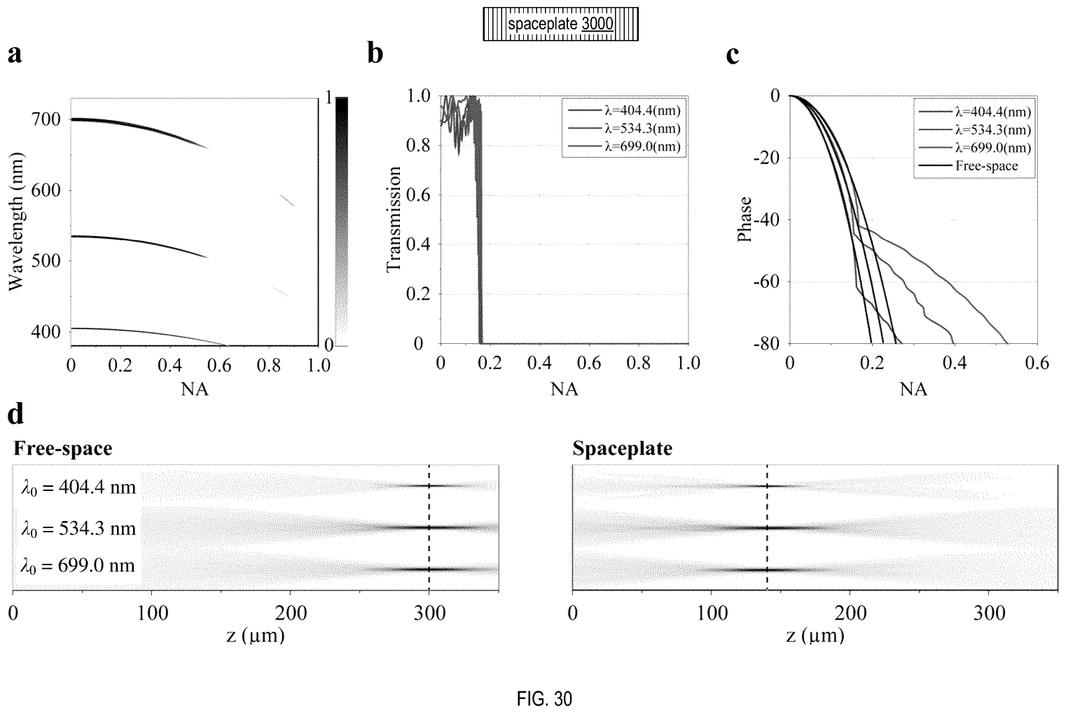

Due to the modularity of the disclosed multi-color spaceplate designs, a longer length of free-space may be replaced (with the same compression ratio) by simply increasing the number of FP cavities in component spaceplates 210, 220, and 230. However, in embodiments, to preserve its achromatic response, as the number of FP cavities increases the composition ratio of N₄₀₅=6: N₅₃₅=5: N₇₀₀=5 is maintained when the same component waveplates are used. As an example, FIG. 30 shows the transmission response of a multi-color spaceplate with N₄₀₅=24, N₅₃₅=20, N₇₀₀=20. The presented results demonstrate again achromatic space compression across the three selected wavelengths but for a longer length of free-space.

FIG. 16 shows the transmission response for TE polarized light incident on the multi-color spaceplate 1200. Plot 1610 shows transmission amplitude profile over the visible spectrum. Multi-color spaceplate 1200 is transparent near the resonance wavelengths of its constituent monochromatic spaceplates. Plot 1620 is of angle-dependent transmission amplitude at the three operating wavelengths λ₀=404.5, 534.3, and 698.8 nm. A high transmission amplitude is maintained within a moderately wide angular range, NA=0.15. Plot 1630 shows that angle-dependent transmission phase of multi-color spaceplate 1200, which closely matches the phase response of free-space at the three operating wavelengths over NA=0.15.

In embodiments or multi-color spaceplate 1200, its thickness is ˜22.47 μm and the spaceplate replaces a free-space length of ˜66.7 μm at λ=404.5 nm, ˜65.7 μm at λ=534.3 nm, and ˜67.1 μm at λ=698.8 nm, corresponding to almost identical compression ratios of C ˜3.0, 2.9, and 3.0, respectively. These results highlight the achromatic performance of multi-color spaceplate 1200 at these three wavelengths. FIG. 17 shows a normalized intensity profile for a TE polarized Gaussian beam (NA=0.05) propagating in vacuum and in the presence multi-color spaceplate 1200, calculated at the three operating wavelengths using the FDTD method. Compared to free-space propagation, the focal plane shifts by ˜42 μm at λ=404.5 nm, ˜39.8 μm at λ=534.3 nm, and ˜40.7 μm at λ=698.8 nm toward the spaceplate. FIG. 17 denotes focal planes 1705 and 1709, which are examples of focal plane 105 and focal plane 109, respectively. FIG. 18 shows normalized intensity profiles across the focal planes 1705 and 1709.

In embodiments, the overall achromatic compression factor of a multi-color spaceplate 200 is lower than that of its component monochromatic spaceplates 210, 220, and 230 operating individually at each wavelength. This is due to the counter space-compression effect introduced by the refraction of light in the rest of the structure, as discussed above. A stronger overall compression effect, however, may be realized by using monochromatic spaceplates with higher individual compression ratios at their resonance wavelengths, while redesigning the stack of layers to maintain achromaticity and high transmission.

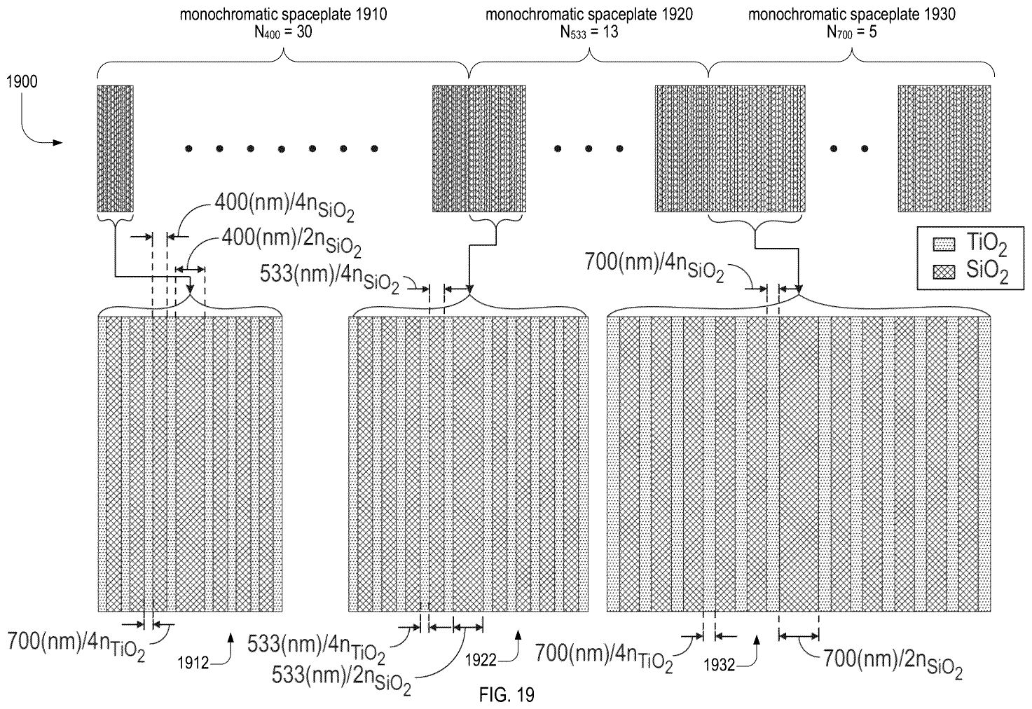

FIG. 19 is a schematic of a multi-color spaceplate 1900, which includes monochromatic spaceplates 1910, 1920, and 1930. Spaceplate 1900 is an example of multi-color spaceplate 200. Spaceplates 1910, 1920, and 1930 are examples of component spaceplate 210, 220, and 230, respectively.

Monochromatic spaceplate 1910 includes thirty FP cavities 1912 each having seven TiO₂/SiO₂ layer pairs in its DBRs, designed at a resonance wavelength λᵣ=400 nm, at which monochromatic spaceplate 1910 has a compression ratio C=9.6. Monochromatic spaceplate 1920 includes thirteen FP cavities 1922 each having nine TiO₂/SiO₂ layer pairs in its DBRs, designed at a resonance wavelength λᵣ=533 nm, at which monochromatic spaceplate 1920 has a compression ratio C=12.3. Monochromatic spaceplate 1930 includes five FP cavities 1932 each having eleven TiO₂/SiO₂ layer pairs in its DBRs, designed at a resonance wavelength λᵣ=700 nm, at which monochromatic spaceplate 1910 has a compression ratio C=19.9. FP cavities 1912, 1922, 1932 are respective examples of optical cavities 412, 422, and 432.

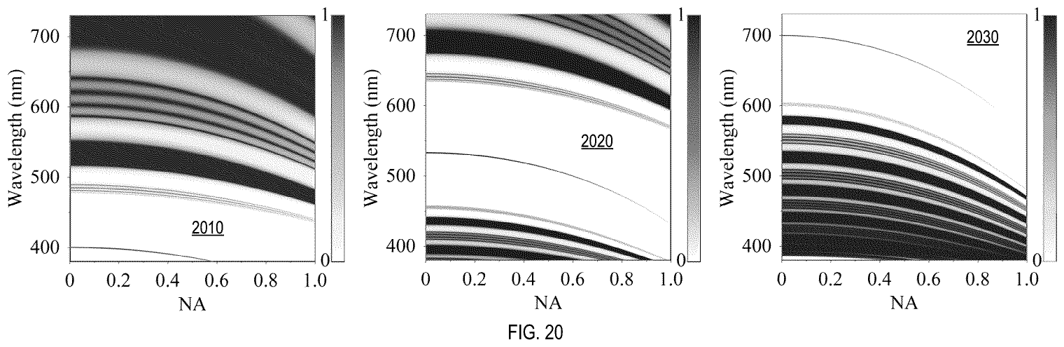

The transmission responses presented in FIGS. 20-22 show that each of monochromatic spaceplates 1910, 1920, and 1930 is transparent to incident light at wavelengths near 400 nm, 533 nm, and 700 nm. FIG. 20 shows transmission plots 2010, 2020, and 2030 of monochromatic spaceplates 1910, 1920, and 1930 respectively, with respect to wavelength and incident angle for transverse-electric (TE) polarized light in free-space.

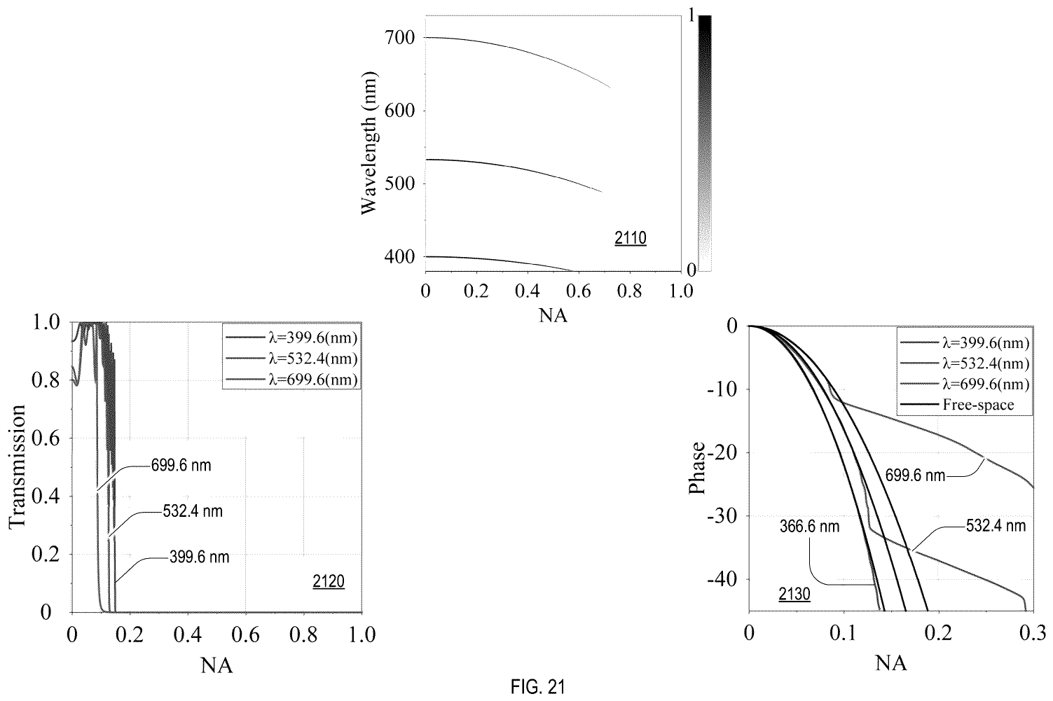

FIG. 21 shows the transmission response of multi-color spaceplate 1900. Plot 2110 shows the wavelength- and angle-dependent transmission profile of multi-color spaceplate 1900 across the visible spectrum. Multi-color spaceplate 1900 has a thickness of approximately 60.1 μm and replaces a free-space length of ˜279.7 μm at λ=399.6 nm, ˜278 μm at λ=532.4 nm, and ˜279.8 μm at λ=699.6 nm, corresponding to an achromatic overall compression ratio of C ˜4.6 at the three wavelengths. Multi-color spaceplate 1900 maintains a high transmission amplitude over NA=0.09, as shown in plots 2120 and 2130 of FIG. 21

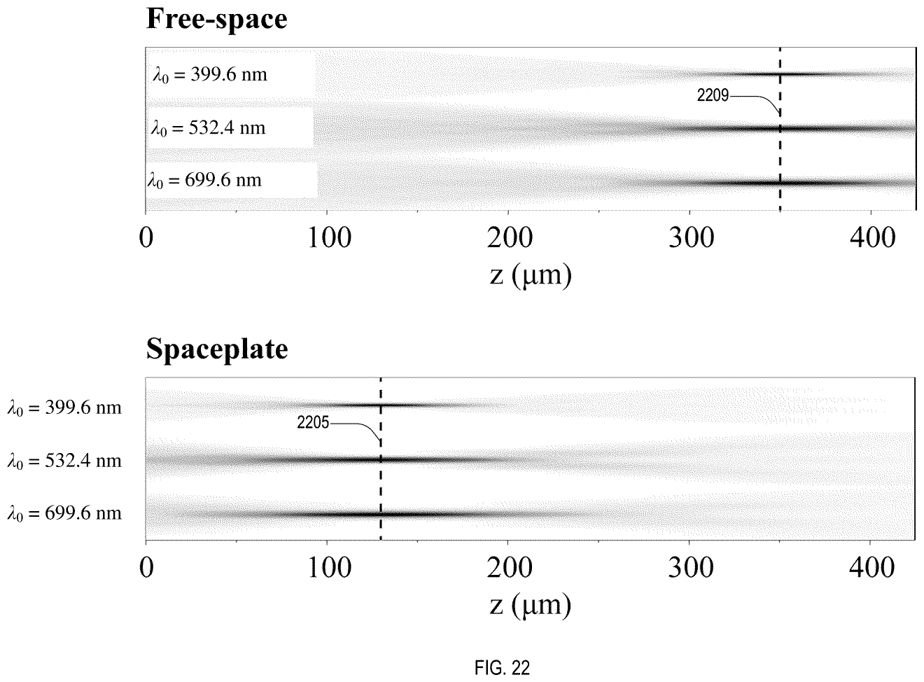

FIG. 22 demonstrates the achromatic performance of multi-color spaceplate 1900 across the three color channels using scalar diffraction theory calculations. FIG. 22 shows a normalized intensity profile for a TE polarized Gaussian beam (NA=0.09) propagating in vacuum and in the presence of the multi-color spaceplate, calculated at three selected wavelengths. FIG. 22 denotes focal planes 2205 and 2209, which are examples of focal plane 105 and focal plane 109, respectively. Focal planes 2205 and 2209 are separated by 221 μm, 224 μm, and 219.5 μm at λ=399.6, 532.4, and 699.6 nm, respectively. The proximity of these values indicates that multi-color spaceplate 1900 has an achromatic response.

### Additional Embodiments and Derivation of Spaceplate Compression Ratio

### 1. Space Compression Based on Fabry-Perot Cavities

A spaceplate has the same optical function as the free-space but with a shorter thickness. The light transmitting through a spaceplate of thickness L effectively experiences a propagation length of L_{eff}>L in free-space, and C=L_{eff}/L determines the compression ratio of the spaceplate.

Based on the Fourier optics analysis, during the propagation between two points separated by L_{eff} along the z-axis, each plane-wave component of the optical field acquires an angle-dependent phase in free-space:

$$ϕ ( {k}_{t} ) = {L}_{eff} \sqrt{{k}_{0}^{2} - {k}_{t}^{2}} \approx {L}_{eff} {k}_{0} - \frac{{L}_{eff} {k}_{t}^{2}}{2 {k}_{0}} \qquad ( 5 )$$

$${k}_{0} = \frac{2 π}{λ} , {k}_{t} = {k}_{0} sin ( θ ) = {k}_{0} NA$$

where k₀, λ, kₜ, and θ are the wavenumber in free-space, the wavelength of light in free-space, the transverse wavenumber, and the angle of incidence relative to the z-axis, respectively. The right hand side of Eq. (5) is the Taylor series expansion of phase for small incident angles. This angle-dependent phase response on Fourier components of the field is known as a “nonlocal” response. In this regard, a nonlocal metasurface with a thinner structure L<L_{eff} and a transmission phase matching the angle-dependent phase response of free-space realizes the space compression.

The Fabry-Pérot (FP) cavity is a simple planar structure transmitting light at selected wavelengths with a nonlocal phase shift. The complex transmission coefficient of the FP cavity made of two similar semi-transparent mirrors with reflectance R, spaced by a distance L is¹

$$t = \frac{( 1 - R ) {e}^{- i δ}}{1 - {Re}^{- i 2 δ}} \qquad ( 6 )$$

$$δ = {k}_{0} {n}_{c} L cos ( {θ}_{c} )$$

where n_{c} and θ_{c} correspond to refractive index of medium and angle of incident inside the cavity, respectively. The complex transmission coefficient can be written as t=|t|e^{-iφ} where the phase shift of the transmitted field is:

$$φ = δ + {tan}^{- 1} ( \frac{R sin ( 2 δ )}{1 - R cos ( 2 δ )} ) \qquad ( 7 )$$

Near the transmission peak at resonance, where δ=7, the Taylor series expansion of the phase is:

$$φ \approx π + \frac{1 + R}{1 - R} ( δ - π ) \qquad ( 8 )$$

where higher-order terms are neglected. Substituting δ from Eq. (6) into Eq. (8), the transmission phase is:

$$φ \approx \frac{- 2 π R}{1 - R} + \frac{1 + R}{1 - R} {k}_{0} {n}_{c} L \sqrt{1 - {sin}^{2} ( {θ}_{c} )} \qquad ( 9 )$$

$$φ \approx \frac{- 2 π R}{1 - R} + \frac{1 + R}{1 - R} L \sqrt{{( {k}_{0} {n}_{c} )}^{2} - {k}_{t}^{2}}$$

For small incident angles, the transmission phase is approximately:

$$φ \approx \frac{- 2 π R}{1 - R} + \frac{1 + R}{1 - R} {Lk}_{0} {n}_{c} - \frac{1 + R}{1 - R} \frac{L}{{n}_{c}} \frac{{k}_{t}^{2}}{2 {k}_{0}} \qquad ( 10 )$$

According to Eq. (10), the transmission phase of the FP cavity near the resonance has the same nonlocal kₜ-dependence as the free-space propagation in Eq. (5). Comparing the coefficients of kₜ-dependent terms in Eq. (5) and Eq. (10) indicates phase response of propagation over a distance of L_{eff} may be realized through an FP cavity with a thickness of L. Therefore, the compression ratio of the FP cavity is:

$$C = \frac{{L}_{eff}}{L} = \frac{1}{{n}_{c}} ( \frac{1 + R}{1 - R} ) \qquad ( 11 )$$

Thus, the compression factor of the FP structure is mainly determined by the reflectance of mirrors and the refractive index of the medium between mirrors.

In an FP cavity, the quadratic term in Eq. (10) that approximates the response of a free-space volume is bounded in the range

$$- π < - ( \frac{1 + R}{1 - R} ) \frac{L}{{n}_{c}} \frac{{k}_{t}^{2}}{2 {k}_{0}} < 0.$$

Thus, a quantitative trade-off between the compression factor and the maximum NA over which an FP cavity performs space compression is:

$$\frac{C}{λ} {LNA}^{2} < 1 \\ NA = {k}_{t} / {k}_{0} \qquad ( 12 )$$

As Eq. (11) and Eq. (12) indicate, FP cavities composed of mirrors with higher reflectance have a narrower angular window of space compression. According to Eq. (12) the distance between the two mirrors (L) also determines the angular range of space compression. An FP cavity with a larger space between the two mirrors has a smaller maximum NA to perform space compression.

### 2. Monochromatic Spaceplates

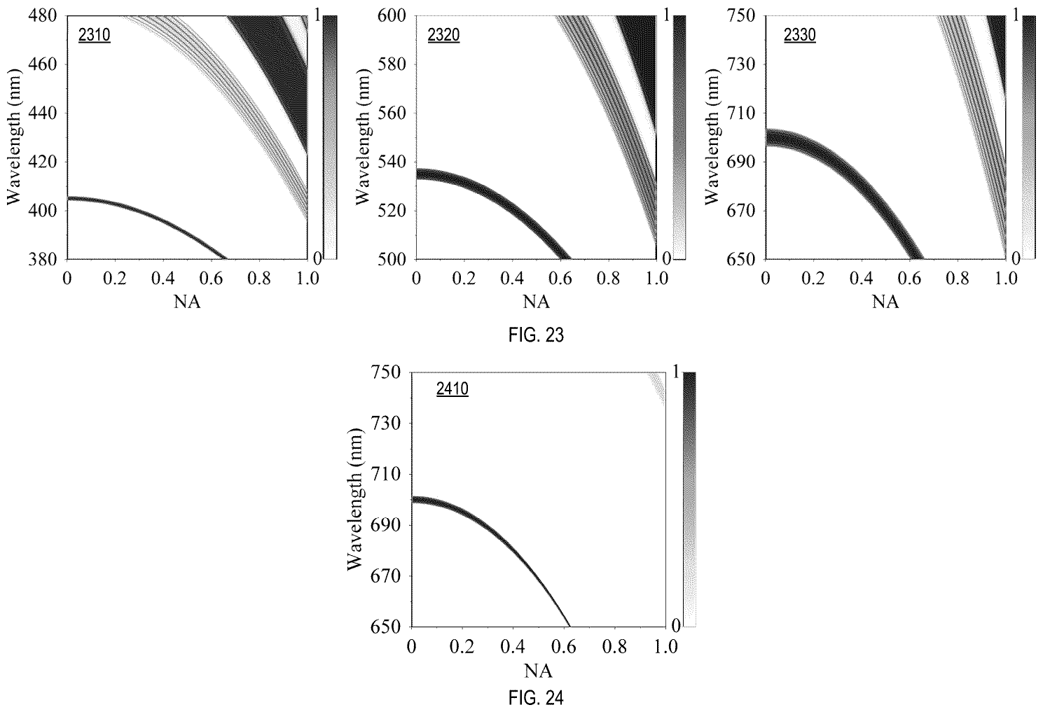

The transverse-invariant structure of FP cavities leads to polarization-insensitive spaceplates. FIG. 23 shows transmission plots 2310, 2320, and 2330 of monochromatic spaceplates 600(1-3) with respect to wavelength and incident angle for transverse-electric (TM) polarized light in free-space. The dark lines correspond to the dispersion curves of the modes supported by the structure. the transmission profile for the transverse-magnetic (TM) polarized incident light closely resembles that of the transverse-electric (TE) polarized light in FIG. 7, within the angular window of space compression.

Increasing the number of layers in distributed Bragg reflectors (DBRs) implemented in FP cavities leads to higher compression ratios. As an illustration, λᵣ=700 nm, we increased the number of DBR layers in monochromatic spaceplate 600 from seven to nine layers. FIG. 24 in includes a plot 2410 showing transmission amplitude and phase of this spaceplate. Plot 2410 is a transmission profile of TE polarized light with respect to the angle of incidence and wavelength. At λ₀=699.05 nm. A relatively high transmission amplitude is maintained over NA=0.14. The spaceplate operated at λ₀=699.05 nm replaces free-space length of ˜202.72 μm with a thickness of ˜20.72 μm, corresponding to compression ratio of 9.8 over NA=0.14. In this example, increasing the number of DBR layers from seven to nine increases the compression ratio by more than a factor of two.

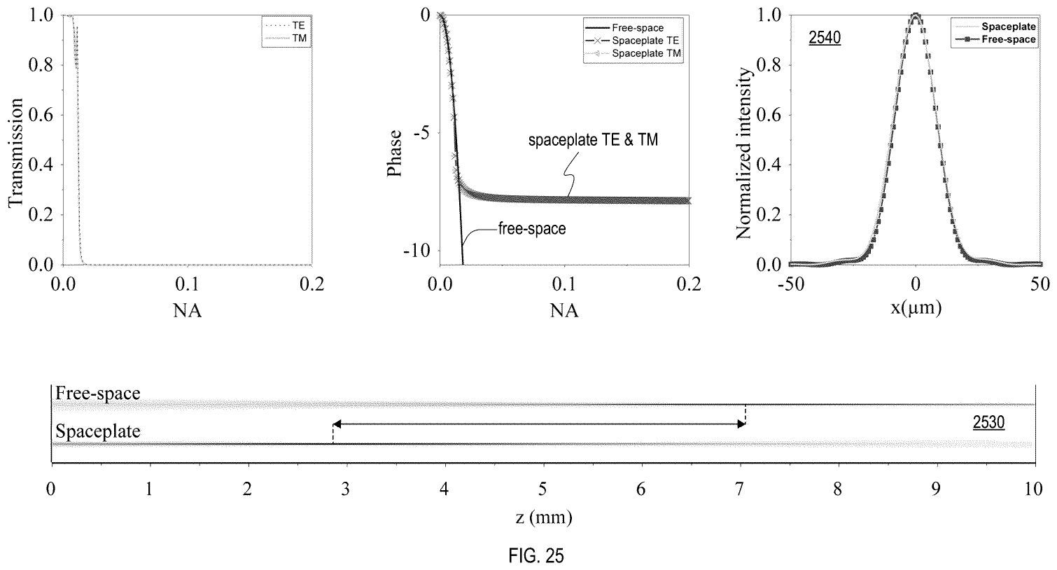

Monochromatic spaceplates with significantly higher compression factors are attainable. As an example, we used fifteen layers of TiO₂ and SiO₂ in DBRs of the FP cavity resonating at λᵣ=405 nm. FIG. 25 shows the transmission response of the spaceplate made of five of these FP cavities. A compression ratio of C ˜470 is realized within NA=0.012. Regarding the trade-off between the compression ratio and angular range of compression, the operating NA of the spaceplate is compromised at high compression ratios.

The spaceplate of FIG. 25 has a thickness of approximately 8.96 μm and replaces free-space length of approximately 4210 μm, which corresponding to the compression ratio of 470 over NA=0.012. Plot 2530 of FIG. 25 is an intensity profile of a TE polarized Gaussian beam (NA=0.01) propagating in vacuum and the spaceplate is calculated based on the scalar diffraction theory. The focal plane of the beam moves 4.2 mm toward the spaceplate. Plot 2540 of FIG. 25 shows that the intensity profile at the focal plane of the beam propagating in the spaceplate is identical to the one in free-space.

The presented strategy for designing monochromatic spaceplates is general and may be applied across various wavelength ranges by selecting suitable materials for that specific range. In the near-infrared range, implementing amorphous Si and SiO₂ layers would result in relatively high space compression effects.

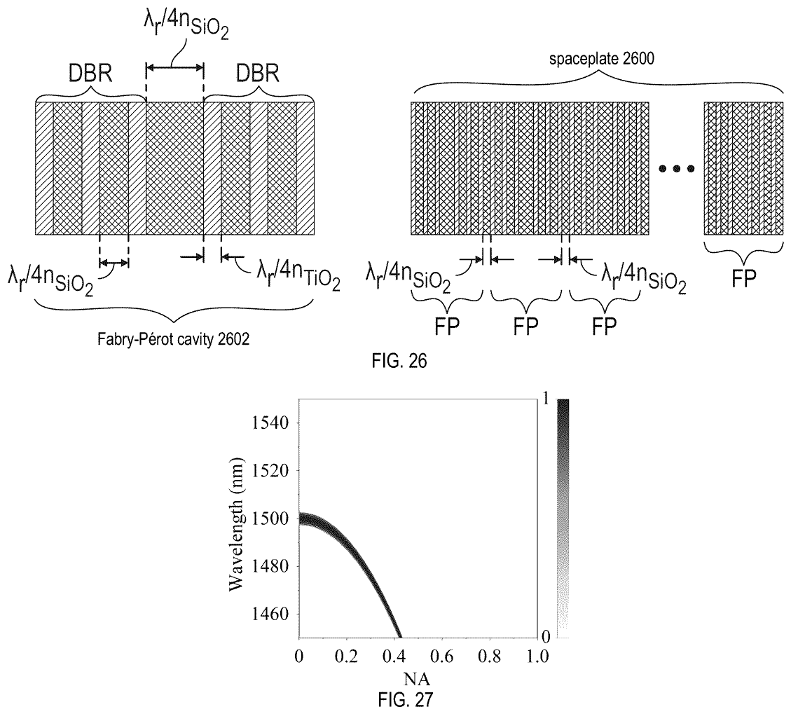

FIG. 26 is a schematic of a monochromatic spaceplate 2600, which is an example of monochromatic spaceplate 600. Spaceplate 2600 includes multiple Fabry-Pérot cavities 2602, each of which is an example of optical cavity 500. Each cavity 2602 includes amorphous Si and SiO₂ layers and has a resonance wavelength λᵣ=1500 nm. FIG. 27 illustrates the transmission response of spaceplate 2600.

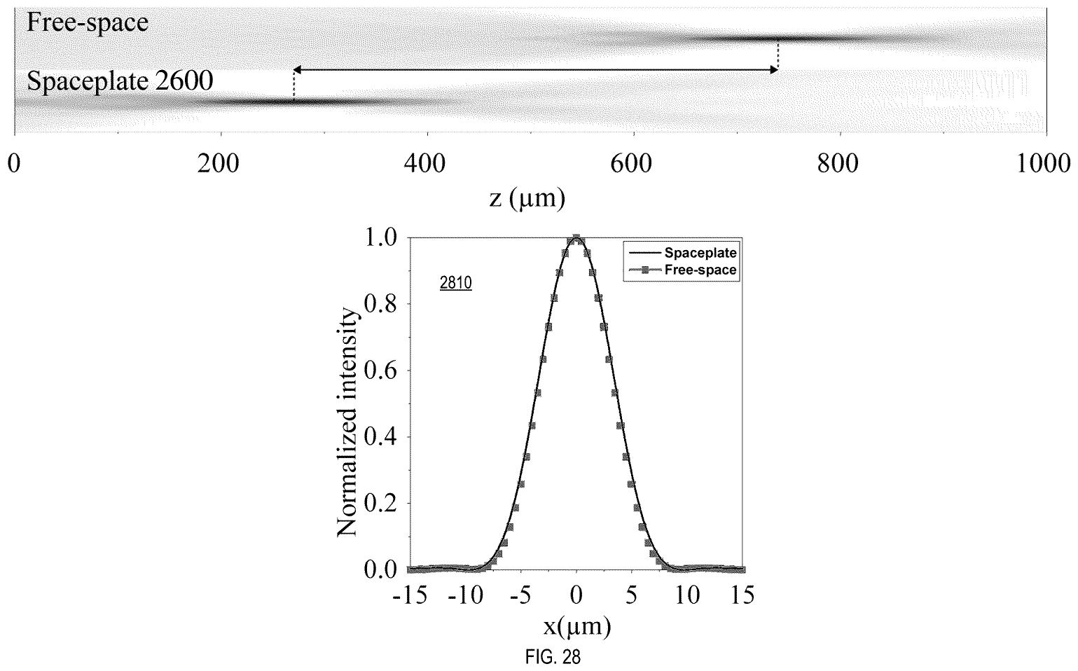

In embodiments, spaceplate 2600 has a thickness of ˜24.6 μm. In such embodiments, spaceplate 2600 replaces free-space length of ˜509.4 μm, corresponding to compression ratio of C ˜20.7 over NA=0.13. FIG. 28 shows the intensity profile of a TE polarized Gaussian beam (NA=0.115) propagating in vacuum and the beam propagation through spaceplate 2600 is calculated based on the scalar diffraction theory. At λ₀=1498.2 nm, focal plane of the beam moves 468 μm toward the spaceplate, corresponding to a space compression ratio of 20. Inset 2810 shows the intensity of the beam at the focal plane for propagating beams in free-space and the spaceplate.

### 3. Multi-Color Spaceplates

For space compression at wavelength λ, the separation space L between the DBRs may be determined by L=mλ/2n_{c}, where n_{c} is the refractive index of the medium filling the cavity and m is a positive integer that specifies orders of resonance in the FP cavity. For designing a multi-color spaceplate with high transmission efficiencies it is advantageous to couple monochromatic spaceplates that are transparent at each of the colors that the space compression is performed. To design the multi-color spaceplates with high transmission efficiencies (e.g., multi-color spaceplate 1200), resonance orders of FP cavities (corresponding to different lengths L) may be used as an additional degree of freedom to control the transmission efficiency of the monochromatic spaceplates over the visible range.

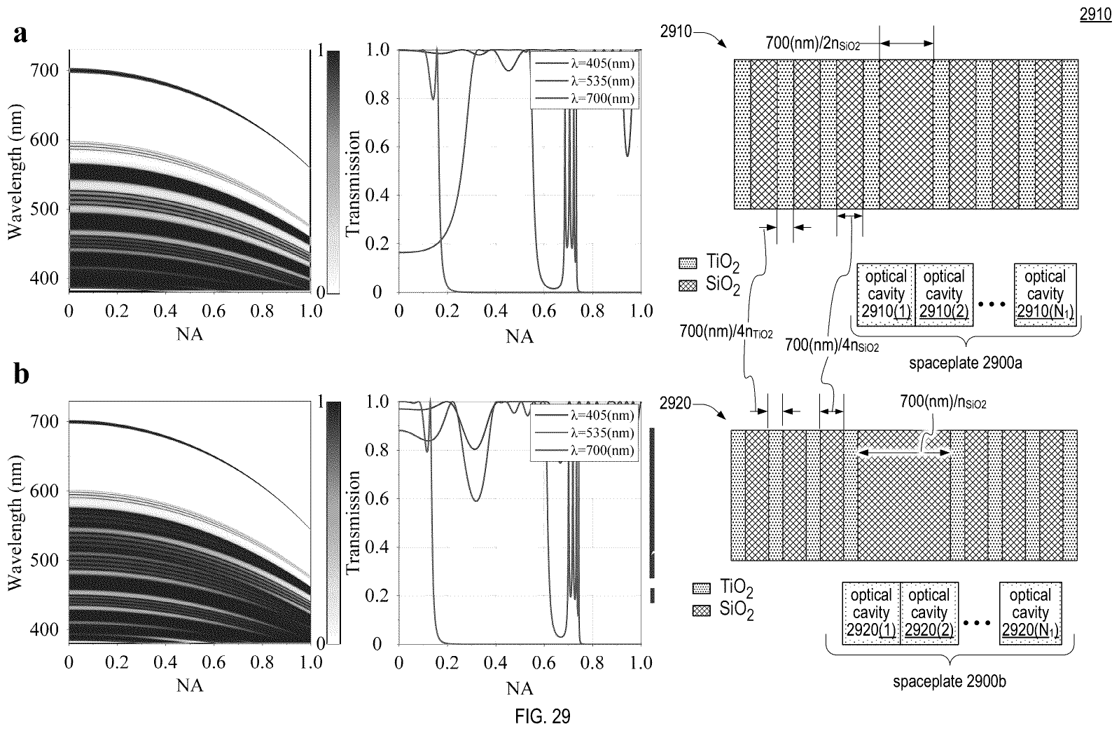

FIG. 29 compares the transmission profile of two monochromatic spaceplates 2900a and 2900b, which are examples of monochromatic spaceplate 600. Spaceplate 2900a includes cascaded optical cavities 2910(1)-2910(N₁). Spaceplate 2900b includes cascaded optical cavities 2920. In the example of FIG. 29, N₁=5.

Spaceplates 2900a and 2900b perform space compression in the first and second orders of resonance at λ=700 nm, respectively. Spaceplate 2900a, with 700 nm/2n_{SiO}_{₂} space between the DBRs (first order of resonance), shows a low transparency at λ=535 nm, as shown in FIG. 29a. However, FIG. 29b indicates that by increasing the space between the DBRs to 700 nm/n_{SiO}_{₂} (second order of resonance, spaceplate 2900b) transmission efficiency at λ=535 nm improves significantly. Comparing FIGS. 29a and 29b also shows that spaceplate 2900b, operating at the second order of resonance (larger separation lengths), has a slightly narrower angular transparency window at resonance wavelength λ=700 nm.

Multi-color spaceplate 1200 performs space compression at three wavelengths, achromatically. Embodiments of multi-color spaceplates that cover a longer range of free-space may be realized by increasing the number of the FP cavities in the constituent monochromatic spaceplates. In embodiments, for an achromatic response at three wavelengths, the composition ratio of N₄₀₅=6: N₅₃₅=5: N₇₀₀=5 is maintained as the number of FP cavities increases.

FIG. 30 shows the transmission response of a multi-color spaceplate 3000, which is an example of multi-color spaceplate 1200 with N₄₀₅=24, N₅₃₅=20, N₇₀₀=20. This analysis demonstrates a space compression ratio of C ˜2.9 across the three wavelengths.

FIG. 30 a-c show a Transmission response of TE polarized light incident on multi-color spaceplate 3000. FIG. 30a is a transmission profile over the visible spectrum. FIG. 30b shows transmission amplitude at three operating wavelengths λ₀=404.4, 534.3, and 699.0 nm. A relatively high transmission efficiency is obtained within NA=0.15. FIG. 30c shows Transmission phase response of the multi-color spaceplate fits the phase shift of free-space propagation at three wavelengths. When spaceplate 3000 has a thickness of ˜89.89 μm, it replaces free-space length of ˜261.6 μm at λ=404.4 nm, ˜261.8 μm at λ=534.3 nm, and ˜262.1 μm at λ=699.0 nm, corresponding to achromatic compression ratio of C ˜2.9 at three wavelengths. FIG. 30d is a normalized intensity profile of a TE polarized Gaussian beam (NA=0.13) propagating in vacuum. Transmission through multi-color spaceplate 3000 is calculated at three wavelengths using scalar diffraction theory. In comparison to the free-space propagation, the focal plane shifts by ˜159.5 μm at λ=404.4 nm, ˜157.5 μm at λ=534.3 nm, and ˜163 μm at λ=699.0 nm toward the spaceplate.

### 4. Transfer-Matrix Method

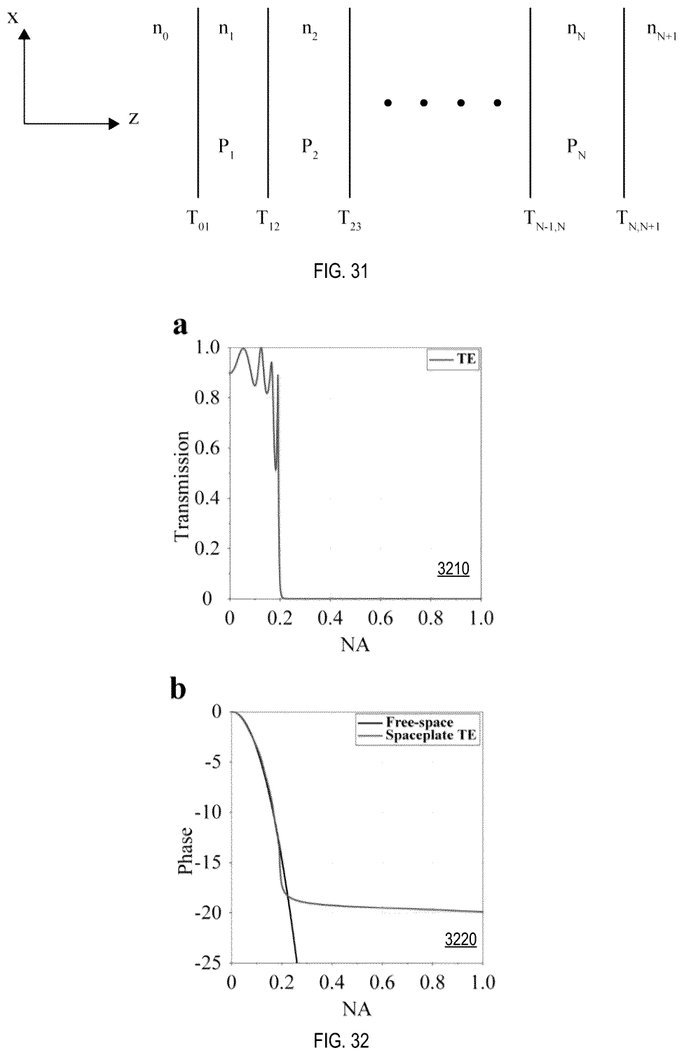

The transfer-matrix method is a general method to analyze the transmission and reflection response of multilayer structures¹, FIG. 31. In a general form, plane waves propagating to the right and left directions in layer nⱼ are E=(Aⱼe^{-ik}^{_{jz}}^{z}+Bⱼe^{+ik}^{_{jz}}^{z}) e^{-ik}^{ⱼₓ}^{x}, where Aⱼ and Bⱼ are the amplitudes of right and left traveling waves, respectively, kⱼₓ is the x component of the wavevector, and k_{jz} is the z component of the wavevector. In FIG. 31, the plane wave amplitudes in medium no are related to plane wave amplitudes in medium n_{N+1}¹:

$$[ \begin{matrix}{A}_{0} \\ {B}_{0}\end{matrix} ] = [ \begin{matrix}{M}_{11} & {M}_{12} \\ {M}_{21} & {M}_{22}\end{matrix} ] [ \begin{matrix}{A}_{N + 1} \\ {B}_{N + 1}\end{matrix} ] = M [ \begin{matrix}{A}_{N + 1} \\ {B}_{N + 1}\end{matrix} ] \\ M = {T}_{01} {P}_{1} {T}_{12} {P}_{2} … {P}_{N - 1} {T}_{N - 1 , N} {P}_{N} {T}_{N , N + 1} \qquad ( 13 )$$

where matrix M is obtained by multiplying transition matrices T_{j,j+1} and propagation matrices Pⱼ in sequence. The transition matrix between layer nⱼ and

$${n}_{j + 1} is {T}_{j , j + 1} = \frac{1}{{t}_{j , j + 1}} [ \begin{matrix}1 & {r}_{j , j + 1} \\ {r}_{j , j + 1} & 1\end{matrix} ] ,$$

where t_{j,j+1} and r_{i,j+1} are the Fresnel transmission and reflection coefficients between the two layers, respectively. For layer nⱼ with dⱼ thickness, the propagation matrix is

$${P}_{j} = [ \begin{matrix}{e}^{{ik}_{jz} {d}_{j}} & 0 \\ 0 & {e}^{- {ik}_{jz} {d}_{j}}\end{matrix} ] .$$

Once matrix M is obtained, the transmission (t) and reflection (r) coefficients of the multilayer structure are calculated:

$$\begin{matrix}t = \frac{1}{{M}_{11}} & r = \frac{{M}_{21}}{{M}_{11}}\end{matrix} \qquad ( 14 )$$

### 5. Scalar Diffraction Theory

Propagating of light in the presence of a spaceplate can be analyzed by using the scalar diffraction theory. For a focusing beam of light with a Gaussian amplitude distribution G(x, y) and phase profile of φ(x, y), the electric field is expressed as:

$${E}_{in} ( x , y ) = G ( x , y ) {e}^{i φ ( x , y )} \qquad ( 15 )$$

The angular spectrum of the electric field is calculated through a Fourier transform:

$$f ( {k}_{x} , {k}_{y} ) = FT \{ {E}_{in} ( x , y ) \} \qquad ( 16 )$$

During the propagation through the spaceplate structure, the angular transmission coefficient of the spaceplate t(kₓ, k_{y}), calculated from transfer-matrix analysis, is applied to the corresponding (kₓ, k_{y}) components of Fourier coefficient of the electric field f(kₓ, k_{y}):

$${f}^{′} ( {k}_{x} , {k}_{y} ) = f ( {k}_{x} , {k}_{y} ) t ( {k}_{x} , {k}_{y} ) \qquad ( 17 )$$

The spatial distribution of the electric field at the outer surface of the spaceplate is then obtained through the inverse Fourier transform:

$${E}_{SP} ( x , y ) = {FT}^{- 1} \{ {f}^{′} ( {k}_{x} , {k}_{y} ) \} \qquad ( 18 )$$

The electric field profile at any plane, which is many wavelengths away from the outer surface of the spaceplate, is calculated based on the Rayleigh-Sommerfeld diffraction formula:

$${E}_{out} ( u , v ) = \frac{1}{i λ} {\int \int }_{\begin{matrix}spaceplate \\ outer surface\end{matrix}} {E}_{SP} ( x , y ) \frac{{e}^{ikr}}{r} cos ( θ ) ds \qquad ( 19 )$$

indicating the Eₒᵤₜ(u, v) is the superposition of the diverging spherical waves originating from point sources on the outer surface of the spaceplate, where r is the distance between point (u,v) on the projection plane and (x,y) on spaceplate, and θ is the angle between vector r and spaceplate outer surface normal. Finally, the intensity distribution is:

$${I}_{out} ( u , v ) = {\vert {E}_{out} ( u , v ) \vert}^{2} \qquad ( 20 )$$

### 6. Fabrication Feasibility

The feasibility of fabricating the disclosed spaceplate structures was investigated by considering an embodiment of monochromatic spaceplate 600 designed at λᵣ=700 nm. This spaceplate includes ten coupled FP cavities, where the DBRs in each FP cavity are composed of seven alternating layers of quarter-wavelength thick TiO₂ and SiO₂. FIG. 32 shows the transmission amplitude (plot 3210) and phase shift (plot 3220) of this spaceplate after introducing ±0.5 nm random fabrication errors in the thickness of each of the TiO₂ layers and SiO₂ layers.

These results show space-compression performance close to that of monochromatic spaceplate 600. This level of accuracy (±0.5 nm) in the fabrication of layers can be afforded through the Atomic Layer Deposition (ALD) method. However, the low deposition rate of layers in ALD (˜0.02˜0.06 nm/cycle) is the main challenge in realizing spaceplates with a large number of layers.

To address this problem, we note that one of the main features of the spaceplate designs presented in this work is that the structure is scalable to many layers by just cascading FP cavities with identical structures. Based on this notion, a large number of FP cavities with identical structures may be fabricated simultaneously inside the ALD chamber and then bonded together to form a spaceplate composed of many layers.

Feasibility of fabricating the spaceplates designed based on the presented approach was investigated. We found that the performance of spaceplates is significantly compromised through the random fabrication errors in the thickness of layers. This is due to the fact that these errors randomly shift the resonance frequency of the Fabry-Pérot (FP) cavities in the spaceplate which disrupts the desired coupling at resonance for space compression.

One of the main features of the spaceplate design presented in this work is cascading FP cavities with similar structures. Based on this notion, a large number of FP cavities with identical structures may be fabricated simultaneously and then bonded together to form a spaceplate. The main advantage of this approach is that the resonance wavelength of the FP cavities may be measured before bonding, and only those within a certain bandwidth (depending on the spaceplate design) are bonded together to form a high performance spaceplate. In this way, we are able to mitigate the effect of random fabrication errors on performance of the spaceplate.

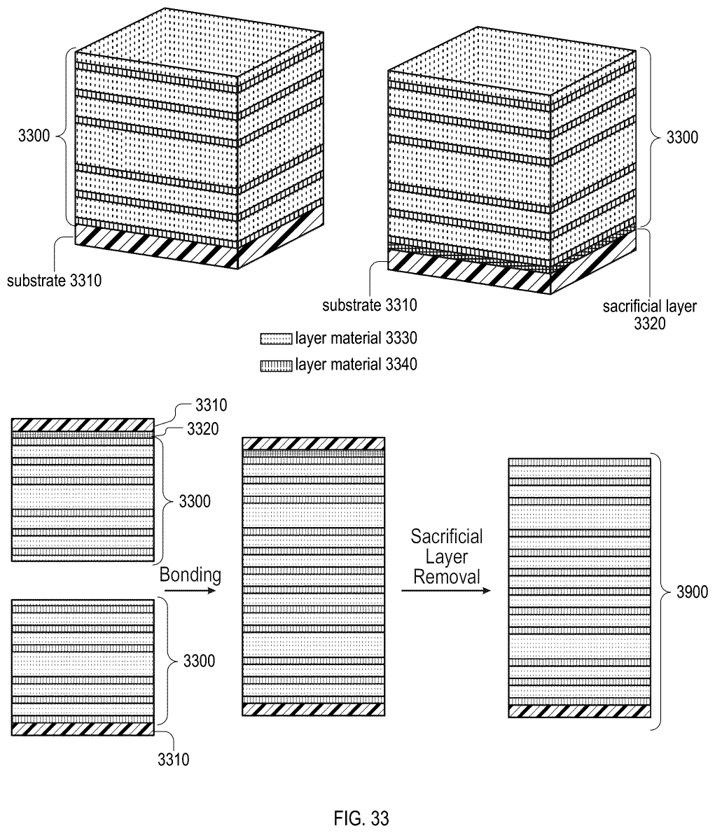

Depending on the materials used in layers of the spaceplate, deposition methods such as atomic layer deposition (ALD), plasma-enhanced chemical vapor deposition (PECVD), electron beam evaporation, and sputtering may be utilized to fabricate FP cavities. FIG. 33 presents an example fabrication method, where each layer is deposited on multiple substrates. As shown in FIG. 33, layers of FP cavities 3300 are deposited on a sacrificial layer 3320, which is on a substrate 3310. The layers are formed of layer materials 3330 and 3340, which may be SiO₂ and TiO₂, for example. FP cavity 3300 is an example of optical cavity 300.

After measuring the resonance wavelength of the FP cavities, those with similar resonance wavelengths are bonded together to yield a spaceplate 3390, which is an example of component spaceplate 410, 420, and 430. Then the carrier substrate is released by removing the sacrificial layer. These bonding and de-bonding steps are repeated to achieve the spaceplate with the desired number of FP cavities. Therefore, spaceplates with a large number of layers may be fabricated through this method.

### Polymeric Bonding

For deposition processes with low temperatures (<200° C.), such as ALD, a positive tone photoresist such as PMMA may be used as the sacrificial layer. This sacrificial layer is removed by UV exposure. Other UV-release polymers such as BrewerBond705 can also be used as the sacrificial layer for deposition processes with higher temperatures (<400° C.). These photoresists and polymers are transparent in visible and NIR spectrum with a refractive index close to SiO₂. A transparent sacrificial layer is crucial for measuring the resonance wavelength of individual FP cavities.

Polymeric bonds are also a low-temperature and low-cost bonding method. Positive tone photoresists such as ZEP520A-2 (60 nm @2000 rpm) or 495 PMMA A2 (65 nm @3000 rpm) might be used as the bonding layer between the FP cavities. Absorption loss of sacrificial layer and materials such as TiO₂ and Si within layers of FP cavity protects the bonding resist from exposure during UV release of the sacrificial layer. Other types of thin-film adhesive polymers such as mr-I 9020 XP are also reported for wafer-level bonding.

### Direct Bonding

Higher quality of bonding may be achieved through direct bonding methods (no intermediate layer) such as surface-activated bonding. This bonding method is performed at room temperature and is compatible with the use of positive tone photoresist and other types of polymers in the sacrificial layer.

Fusion bonding is another direct bonding technique performed at high temperatures (˜550° C.) for SiO₂: SiO₂ bonding of the FP cavities. Regarding the high temperature required for this type of boding, polymeric sacrificial layers cannot be used. We suggest indium tin oxide (ITO) as the sacrificial layer. Thin layers of ITO are deposited on a glass substrate using the sputtering technique. ITO is transparent in the visible spectrum which is crucial for measuring the resonance wavelength of FP cavities before the bonding step. ITO is removed using the etchant TE-100 (Transene, Inc.) at 30˜40° C. temperature with high selectivity to SiO₂, TiO₂, or Si layers.

For spaceplates composed of Si and SiO₂ layers, designed to operate at near-infrared, anodic bonding can also be used for Si:SiO₂ bonding of FP cavities. Anodic bonding is usually performed at ˜400° C.. We suggest germanium (Ge) as the sacrificial layer for the fabrication of this type of spaceplates. Thin layers of Ge are deposited on a glass substrate using the sputtering technique which is relatively transparent in near-infrared range. Hydrogen peroxide (H₂O₂) is a well-known etchant for Ge with high selectivity to SiO₂ and Si layers.

### Combinations of Features

Features described above, as well as those claimed below, may be combined in various ways without departing from the scope hereof. The following enumerated examples illustrate some possible, non-limiting combinations.

Embodiment 1. A multi-color spaceplate includes a first component spaceplate and a second component spaceplate cascaded with the first component spaceplate. The first component spaceplate has an on-resonance compression ratio C₁₁ at a first resonance wavelength and, at a second resonance wavelength, an off-resonance compression ratio C₂₁, that is less than the on-resonance compression ratio C₁₁. The second component spaceplate has an on-resonance compression ratio C₂₂ at the second resonance wavelength and, at the first resonance wavelength, an off-resonance compression ratio C₁₂ that is less than the on-resonance compression ratio C₂₂.

Embodiment 2. The multi-color spaceplate of embodiment 1, each of the on-resonance compression ratios C₁₁ and C₂₂ being greater than two.

Embodiment 3. The multi-color spaceplate of embodiment 1, each of the off-resonance compression ratios C₂₁ and C₁₂ being less than or equal to one.

Embodiment 4. The multi-color spaceplate of any one of embodiments 1˜3, further comprising: a third component spaceplate cascaded with the first component spaceplate and the second component spaceplate, and having (i) an on-resonance compression ratio C₃₃ at a third resonance wavelength, (ii) at the first resonance wavelength, an off-resonance compression ratio C₁₃ that is less than the on-resonance compression ratio C₃₃, and (iii) at the second resonance wavelength, an off-resonance compression ratio C₂₃ that is less than the on-resonance compression ratio C₃₃.

Embodiment 5. The multi-color spaceplate of embodiment 4, the on-resonance compression ratio C₃₃ being greater than two.

Embodiment 6. The multi-color spaceplate of either one of embodiments 4 or 5, each of the off-resonance compression ratios C₁₃ and C₂₃ being less than or equal to one.

Embodiment 7. The multi-color spaceplate of any one of embodiments 1-6, the first component spaceplate including N₁ cascaded optical cavities each having a resonance at the first resonance wavelength, each optical cavity including a pair of first distributed Bragg reflectors (DBR) separated by a first cavity layer having a thickness equal to m₁λ₁/2n₁, where λ₁ is the first resonance wavelength, n₁ is the refractive index of the first cavity layer at the first resonance wavelength, and both N₁ and m₁ are integers; and the second component spaceplate including N₂ cascaded optical cavities each having a resonance at the second resonance wavelength, each optical cavity including a pair of second DBRs separated by a second cavity layer having a thickness equal to m₂λ₂/2n₂, where λ₂ is the second resonance wavelength, n₂ is the refractive index of the second cavity layer at the second resonance wavelength, and both N₂ and m₂ are integers.

Embodiment 8. The multi-color spaceplate of embodiment 7, further comprising: a third component spaceplate having (i) an on-resonance compression ratio C₃₃ at a third resonance wavelength, (ii) at the first resonance wavelength, an off-resonance compression ratio C₁₃ that is less than the compression ratio C₃₃, and (iii) at the second resonance wavelength, an off-resonance compression ratio C₂₃ that is less than the compression ratio C₃₃, and the third component spaceplate including N₃ cascaded optical cavities each having a resonance at the third resonance wavelength, each optical cavity including a pair of third DBRs separated by a third cavity layer having a length (e.g. a geometric length) or thickness equal to m₃λ₃/2n₃, where λ₃ is the third resonance wavelength, n₃ is the refractive index of the third cavity layer at the third resonance wavelength, and both N₃ and m₃ are integers.

Embodiment 9. The multi-color spaceplate of embodiment 8, one of m₁, m₂, and m₃ equaling one, and the remaining two of m₁, m₂, and m₃ equaling two.

Embodiment 10. The multi-color spaceplate of embodiment 8, m₁ equaling 1, and the first resonance wavelength being less than each of the second resonance wavelength and the third resonance wavelength.

Embodiment 11. The multi-color spaceplate of embodiment 8, wherein each of m₁, m₂, and m₃ equals one.

Embodiment 12. The multi-color spaceplate of any one of embodiments 8-11, the first resonance wavelength being between 380 nm and 490 nm, the second resonance wavelength being between 490 nm and 560 nm, and the third resonance wavelength being between 570 nm and 750 nm.

Embodiment 13. The multi-color spaceplate of any one of embodiments 8-11, wherein and N₂ equals 5N₁/6 and N₃ equals N₂.

Embodiment 14. The multi-color spaceplate of any one of embodiments 8-11, wherein N₁ equals thirty, N₂ equals thirteen, and N₃ equals five.

Embodiment 15. The multi-color spaceplate of any one of embodiments 7-14, the first and second component spaceplates having respective lengths (e.g. a geometric length or thickness) L₁ and L₂, and respective focal-point shifts F₁ and F₂, where F₁=L₁(C₁₁+C₁₂+C₁₃) and F₂=L₂(C₂₁+C₂₂+C₂₃), lengths L₁ and L₂ are determined in part by N₁ and N₂, respectively, and N₁ and N₂ are integers that minimize a differences between focal-point shifts F₁ and F₂.

Embodiment 16. The multi-color spaceplate of any one of embodiments 8˜15, the first, second, and third component spaceplates having respective lengths (e.g. a geometric length or thickness) L₁, L₂, and L₃ and respective focal-point shifts F₁, F₂, and F₃, where F₁=L₁(C₁₁+C₁₂+C₁₃), F₂=L₂(C₂₁+C₂₂+C₂₃), and F₃=L₃(C₃₁+C₃₂+C₃₃), lengths L₁, L₂, and L₃ are determined in part by N₁, N₂, and N₃, respectively, and N₁, N₂, and N₃ are integers that minimize differences between focal-point shifts F₁, F₂, and F₃.

Embodiment 17. The multi-color spaceplate of any one of embodiments 7-16, each of the first DBR and the second DBR including multiple alternating layers of silicon dioxide and titanium dioxide.

Embodiment 18. The multi-color spaceplate of any one of embodiments 1-17, the first component spaceplate including a first plurality of material layers, the off-resonance compression ratio C₂₁ exceeding 1/nₘₐₓ₁, where nₘₐₓ₁ is the maximum refractive index of the first plurality of material layers; and the second component spaceplate including a second plurality of material layers, the off-resonance compression ratio C₁₂ exceeding 1/nₘₐₓ₂, where nₘₐₓ₂ is the maximum refractive index of the second plurality of material layers.

Embodiment 19. The multi-color spaceplate of any one of embodiments 8-18, the first component spaceplate having, at the third resonance wavelength, an off-resonance compression ratio C₃₁ that is less than the on-resonance compression ratio C₁₁; and the second component spaceplate having, at the third resonance wavelength, an off-resonance compression ratio C₃₂ that is less than the on-resonance compression ratio C₂₂.

Embodiment 20. The multi-color spaceplate of embodiment 19, the first component spaceplate including a first plurality of material layers, each of the off-resonance compression ratios C₂₁ and C₃₁ exceeding 1/nₘₐₓ₁, where nₘₐₓ₁ is the maximum refractive index of the first plurality of material layers; the second component spaceplate including a second plurality of material layers, each of the off-resonance compression ratios C₁₂ and C₃₂ exceeding 1/nₘₐₓ₂, where nₘₐₓ₂ is the maximum refractive index of the second plurality of material layers, and the third component spaceplate including a third plurality of material layers, each of the off-resonance compression ratios C₁₃ and C₂₃ exceeding 1/nₘₐₓ₃, where nₘₐₓ₃ is the maximum refractive index of the third plurality of material layers.

Changes may be made in the above methods and systems without departing from the scope of the present embodiments. It should thus be noted that the matter contained in the above description or shown in the accompanying drawings should be interpreted as illustrative and not in a limiting sense. Herein, and unless otherwise indicated the phrase “in embodiments” is equivalent to the phrase “in certain embodiments,” and does not refer to all embodiments.

Regarding instances of the terms “and/or” and “at least one of,” for example, in the cases of “A and/or B,” “at least one of A and B,” and “at least one of A or B,” such phrasing encompasses the selection of (i) A only, or (ii) B only, or (iii) both A and B. In the cases of “A, B, and/or C,” “at least one of A, B, and C,” and “at least one of A, B, or C,” such phrasing encompasses the selection of (i) A only, or (ii) B only, or (iii) C only, or (iv) A and B only, or (v) A and C only, or (vi) B and C only, or (vii) each of A and B and C. This may be extended for as many items as are listed.

The following claims are intended to cover all generic and specific features described herein, as well as all statements of the scope of the present method and system, which, as a matter of language, might be said to fall therebetween.

We claim:

1. A multi-color spaceplate comprising:
a first component spaceplate having an on-resonance compression ratio C₁₁ at a first resonance wavelength and, at a second resonance wavelength, an off-resonance compression ratio C₂₁, that is less than the on-resonance compression ratio C₁₁; and
a second component spaceplate, cascaded with the first component spaceplate, and having an on-resonance compression ratio C₂₂ at the second resonance wavelength and, at the first resonance wavelength, an off-resonance compression ratio C₁₂ that is less than the on-resonance compression ratio C₂₂.

2. The multi-color spaceplate of claim 1, each of the on-resonance compression ratios C₁₁ and C₂₂ being greater than two.

3. The multi-color spaceplate of claim 1, each of the off-resonance compression ratios C₂₁ and C₁₂ being less than or equal to one.

4. The multi-color spaceplate of claim 1, further comprising:
a third component spaceplate cascaded with the first component spaceplate and the second component spaceplate, and having (i) an on-resonance compression ratio C₃₃ at a third resonance wavelength, (ii) at the first resonance wavelength, an off-resonance compression ratio C₁₃ that is less than the on-resonance compression ratio C₃₃, and (iii) at the second resonance wavelength, an off-resonance compression ratio C₂₃ that is less than the on-resonance compression ratio C₃₃.

5. The multi-color spaceplate of claim 4, the on-resonance compression ratio C₃₃ being greater than two.

6. The multi-color spaceplate of claim 4, each of the off-resonance compression ratios C₁₃ and C₂₃ being less than or equal to one.

7. The multi-color spaceplate of claim 1,
the first component spaceplate including N₁ cascaded optical cavities each having a resonance at the first resonance wavelength, each optical cavity including a pair of first distributed Bragg reflectors (DBR) separated by a first cavity layer having a thickness equal to m₁λ₁/2n₁, where λ₁ is the first resonance wavelength, n₁ is the refractive index of the first cavity layer at the first resonance wavelength, and both N₁ and m₁ are integers; and
the second component spaceplate including N₂ cascaded optical cavities each having a resonance at the second resonance wavelength, each optical cavity including a pair of second DBRs separated by a second cavity layer having a thickness equal to m₂λ₂/2n₂, where λ₂ is the second resonance wavelength, n₂ is the refractive index of the second cavity layer at the second resonance wavelength, and both N₂ and m₂ are integers.

8. The multi-color spaceplate of claim 7, further comprising:
a third component spaceplate having (i) an on-resonance compression ratio C₃₃ at a third resonance wavelength, (ii) at the first resonance wavelength, an off-resonance compression ratio C₁₃ that is less than the compression ratio C₃₃, and (iii) at the second resonance wavelength, an off-resonance compression ratio C₂₃ that is less than the compression ratio C₃₃, and
the third component spaceplate including N₃ cascaded optical cavities each having a resonance at the third resonance wavelength, each optical cavity including a pair of third DBRs separated by a third cavity layer having a length (e.g. a geometric length) or thickness equal to m₃λ₃/2n₃, where λ₃ is the third resonance wavelength, n₃ is the refractive index of the third cavity layer at the third resonance wavelength, and both N₃ and m₃ are integers.

9. The multi-color spaceplate of claim 8, one of m₁, m₂, and m₃ equaling one, and the remaining two of m₁, m₂, and m₃ equaling two.

10. The multi-color spaceplate of claim 8, m₁ equaling 1, and the first resonance wavelength being less than each of the second resonance wavelength and the third resonance wavelength.

11. The multi-color spaceplate of claim 8, wherein each of m₁, m₂, and m₃ equals one.

12. The multi-color spaceplate of claim 8, the first resonance wavelength being between 380 nm and 490 nm, the second resonance wavelength being between 490 nm and 560 nm, and the third resonance wavelength being between 570 nm and 750 nm.

13. The multi-color spaceplate of claim 8, wherein and N₂ equals 5N₁/6 and N₃ equals N₂.

14. The multi-color spaceplate of claim 8, wherein N₁ equals thirty, N₂ equals thirteen, and N₃ equals five.

15. The multi-color spaceplate of claim 7,
the first and second component spaceplates having respective lengths (e.g. a geometric length or thickness) L₁ and L₂, and respective focal-point shifts F₁ and F₂, where
$${F}_{1} = {L}_{1} ( {C}_{11} + {C}_{12} + {C}_{13} ) and {F}_{2} = {L}_{2} ( {C}_{21} + {C}_{22} + {C}_{23} ) ,$$
lengths L₁ and L₂ are determined in part by N₁ and N₂, respectively, and N₁ and N₂ are integers that minimize a differences between focal-point shifts F₁ and F₂.

16. The multi-color spaceplate of claim 8,
the first, second, and third component spaceplates having respective lengths (e.g. a geometric length or thickness) L₁, L₂, and L₃ and respective focal-point shifts F₁,
$${F}_{2} , and {F}_{3} , where {F}_{1} = {L}_{1} ( {C}_{11} + {C}_{12} + {C}_{13} ) , \\ {F}_{2} = {L}_{2} ( {C}_{21} + {C}_{22} + {C}_{23} ) , and {F}_{3} = {L}_{3} ( {C}_{31} + {C}_{32} + {C}_{33} ) ,$$
lengths L₁, L₂, and L₃ are determined in part by N₁, N₂, and N₃, respectively, and N₁, N₂, and N₃ are integers that minimize differences between focal-point shifts F₁, F₂, and F₃.

17. The multi-color spaceplate of claim 7, each of the first DBR and the second DBR including multiple alternating layers of silicon dioxide and titanium dioxide.

18. The multi-color spaceplate of claim 1,
the first component spaceplate including a first plurality of material layers, the off-resonance compression ratio C₂₁ exceeding 1/nₘₐₓ₁, where nₘₐₓ₁ is the maximum refractive index of the first plurality of material layers; and
the second component spaceplate including a second plurality of material layers, the off-resonance compression ratio C₁₂ exceeding 1/nₘₐₓ₂, where nₘₐₓ₂ is the maximum refractive index of the second plurality of material layers.

19. The multi-color spaceplate of claim 8,
the first component spaceplate having, at the third resonance wavelength, an off-resonance compression ratio C₃₁ that is less than the on-resonance compression ratio C₁₁; and
the second component spaceplate having, at the third resonance wavelength, an off-resonance compression ratio C₃₂ that is less than the on-resonance compression ratio C₂₂.

20. The multi-color spaceplate of claim 19,
the first component spaceplate including a first plurality of material layers, each of the off-resonance compression ratios C₂₁ and C₃₁ exceeding 1/nₘₐₓ₁, where nₘₐₓ₁ is the maximum refractive index of the first plurality of material layers;
the second component spaceplate including a second plurality of material layers, each of the off-resonance compression ratios C₁₂ and C₃₂ exceeding 1/nₘₐₓ₂, where nₘₐₓ₂ is the maximum refractive index of the second plurality of material layers, and
the third component spaceplate including a third plurality of material layers, each of the off-resonance compression ratios C₁₃ and C₂₃ exceeding 1/nₘₐₓ₃, where nₘₐₓ₃ is the maximum refractive index of the third plurality of material layers.
